(19) United States
(12) Patent Application Publication
(10) Pub. No.: US 2011/0309270 A1
(43) Pub. Date: Dec. 22, 2011

(54) LASER DEVICE, EXTREME ULTRAVIOLET LIGHT GENERATION DEVICE, AND METHOD FOR MAINTAINING THE DEVICES

(76) Inventors: Yohichi Yamanouchi, Tochigi (JP); Takashi Suganuma, Tochigi (JP); Junichi Fujimoto, Tochigi (JP); Osamu Wakabayashi, Kanagawa (JP); Hiroaki Nakarai, Tochigi (JP); Hidenobu Kameda, Tochigi (JP); Hitoshi Oga, Tochigi (JP)

(21) Appl. No.: 13/120,998

(22) PCT Filed: Feb. 16, 2011
(86) PCT No.: PCT/JP2011/053881

§ 371 Date: Sep. 9, 2011

(30) Foreign Application Priority Data
Feb. 19, 2010 (JP) 2010-035440
Dec. 16, 2010 (JP) 2010-280981

(51) Int. Cl. G01J 3/10; H01S 3/091

(52) U.S. Cl. 250/504 R; 372/70

(57) ABSTRACT

Provided is a laser device which is installed within a predetermined space and on a predetermined floor area, the laser device may includes: a master oscillator; at least one amplifier unit that amplifies a laser beam outputted from the master oscillator; at least one power source unit that supplies excitation energy to the at least one amplifier unit; and a movement mechanism which enables at least one among the at least one amplifier unit and the at least one power source unit to be moved in a direction parallel with a floor surface.

### CROSS-REFERENCE TO RELATED APPLICATIONS

The present application claims priority from Japanese Patent Application No. 2010-035440 filed on Feb. 19, 2010 and from Japanese Patent Application No. 2010-280981 filed on Dec. 16, 2010, the disclosure of each of which is incorporated herein by reference in its entirety.

### BACKGROUND

1. Technical Field

The present disclosure relates to a laser device, an extreme ultraviolet light generation device, and a method for maintaining the devices.

2. Description of Related Art

In recent years, as semiconductor processes become finer, photolithography has been making rapid progress toward finer fabrication. In the next generation, microfabrication at 70 nm to 45 nm, further, microfabrication at 32 nm and beyond will be required. Accordingly, in order to fulfill the requirement for microfabrication at 32 nm and beyond, for example, an exposure device is expected to be developed where an EUV light generation device for generating EUV light having a wavelength of approximately 13 nm is combined with reduced projection reflective optics.

As the EUV light generation device, there are three kinds of light generation devices, which include an LPP (laser produced plasma) type light generation device using plasma generated by irradiating a target material with a laser beam, a DPP (discharge produced plasma) type light generation device using plasma generated by electric discharge, and an SR (synchrotron radiation) type light generation device using orbital radiation. (See, for example, JP-A-2006-128157)

### SUMMARY

A laser device which is installed within a predetermined space and on a predetermined floor area in accordance with one aspect of this disclosure may include: a master oscillator; at least one amplifier unit that amplifies a laser beam outputted from the master oscillator; at least one power source unit that supplies excitation energy to the at least one amplifier unit; and a movement mechanism which enables at least one among the at least one amplifier unit and the at least one power source unit to be moved in a direction parallel with a floor surface.

An extreme ultraviolet light generation device in accordance with another aspect of this disclosure may include: a laser device, disposed in a predetermined space, having a master oscillator, at least one amplifier unit that amplifies a laser beam outputted from the master oscillator, at least one power source unit that supplies excitation energy to the at least one amplifier unit, a switchboard for distributing power to the at least one power source unit, and a movement mechanism for enabling at least one among the at least one amplifier unit and the at least one power source unit to be moved with respect to the switchboard; and a chamber, disposed outside the predetermined space, in which a target serving as a source of extreme ultraviolet light is irradiated with a laser beam outputted from the laser device.

These and other objects, features, aspects, and advantages of the present disclosure will become apparent to those skilled in the art from the following detailed description, which, taken in conjunction with the annexed drawings, discloses preferred embodiments of the present disclosure.

### BRIEF DESCRIPTION OF THE DRAWINGS

FIG. 1 is a block diagram illustrating a schematic configuration of a laser device in accordance with an embodiment of the present disclosure.

FIG. 2 is a schematic diagram illustrating an exemplary configuration of a switchboard in accordance with the embodiment.

FIG. 3 is a perspective view illustrating an exemplary layout of the laser device, which is in operation, accommodated in an installation space in accordance with the embodiment.

FIG. 4 is a top view illustrating an exemplary layout of the laser device, which is in operation, accommodated in an installation space in accordance with the embodiment.

FIG. 5A is a top view illustrating an exemplary layout of the laser device, which is under maintenance, accommodated in the installation space in accordance with the embodiment.

FIG. 5B is a top view illustrating an exemplary layout of the laser device, which is under maintenance, accommodated in the installation space in accordance with the embodiment.

FIG. 6 is a top view illustrating another exemplary layout of the laser device accommodated in the installation space in accordance with the embodiment.

FIG. 7 is a top view illustrating yet another exemplary layout of the laser device accommodated in the installation space in accordance with the embodiment.

FIG. 8A is a top view illustrating yet another exemplary layout of the laser device accommodated in the installation space in accordance with the embodiment.

FIG. 8B is a top view illustrating yet another exemplary layout of the laser device accommodated in the installation space in accordance with the embodiment.

FIG. 9A is a side view of a fourth power source unit and a movement mechanism viewed in a direction of the movement in accordance with the embodiment.

FIG. 9B is a side view of the fourth power source unit, a fifth power source unit, and the movement mechanism viewed in a direction perpendicular to the direction of the movement in accordance with the embodiment.

FIG. 10 is a side view of a fourth power source unit and a movement mechanism viewed in a direction perpendicular to the direction of the movement in accordance with a modification of the embodiment.

FIG. 11 is a side view illustrating a first exemplary configuration of a movement support mechanism in accordance with the embodiment.

FIG. 12 is a side view illustrating a second exemplary configuration of the movement support mechanism in accordance with the embodiment.

FIG. 13 is a side view illustrating a third exemplary configuration of the movement support mechanism in accordance with the embodiment.

FIG. 14A is a top view illustrating an exemplary configuration of an optical unit anchored onto a floor surface in accordance with the embodiment.

FIG. 14B is a side view illustrating an exemplary configuration of the optical unit anchored onto the floor surface in accordance with the embodiment.

FIG. 14C is a side view illustrating an exemplary configuration of the optical unit anchored onto the floor surface in accordance with the embodiment.

FIG. 15 is a side view illustrating an exemplary configuration in which the optical unit is anchored to an OSC unit group in accordance with the embodiment.

FIG. 16 is a side view illustrating an exemplary configuration in which the optical unit is anchored to the fourth and fifth amplifier units in accordance with the embodiment.

FIG. 17A is a side view illustrating a schematic configuration of the optical unit in accordance with the embodiment.

FIG. 17B is a rear view illustrating a schematic configuration of the optical unit in accordance with the embodiment.

FIG. 18A is a diagram illustrating an exemplary configuration of a first relay optical system in the optical unit in accordance with the embodiment.

FIG. 18B is a diagram illustrating an exemplary configuration of a second relay optical system in the optical unit in accordance with the embodiment.

FIG. 18C is a diagram illustrating an exemplary configuration of a third relay optical system in the optical unit in accordance with the embodiment.

FIG. 19 is a schematic diagram illustrating another configuration of the optical unit in accordance with the embodiment.

FIG. 20 is a diagram illustrating another exemplary configuration of the second relay optical system in the optical unit in accordance with the embodiment.

FIG. 21 is a schematic diagram illustrating yet another configuration of the optical unit in accordance with the embodiment.

FIG. 22 is a diagram illustrating another exemplary configuration of the first relay optical system in the optical unit in accordance with the embodiment.

FIG. 23 is a schematic diagram illustrating yet another configuration of the optical unit in accordance with the embodiment.

FIG. 24 is a diagram illustrating another exemplary configuration of the third relay optical system in the optical unit in accordance with the embodiment.

FIG. 25 is a schematic diagram illustrating an exemplary configuration for monitoring outputs from the fourth and fifth amplifier units in accordance with the embodiment.

FIG. 26 is a perspective view illustrating an exterior configuration of the fourth or fifth amplifier unit in accordance with the embodiment.

FIG. 27 is a side view illustrating a schematic configuration of the interior of the fourth amplifier unit in accordance with the embodiment.

FIG. 28 is an exploded view of the fourth amplifier unit shown in FIG. 27.

FIG. 29 is a top view illustrating a schematic configuration of a gas path located at an upper stage in the fourth amplifier unit shown in FIG. 27.

FIG. 30 is a top view illustrating a schematic configuration of an amplification path located at a middle stage in the fourth amplifier shown in FIG. 27.

FIG. 31A is an internal side view illustrating an exemplary antivibration mechanism inside an amplifier in accordance with the embodiment.

FIG. 31B is a partial arrangement diagram illustrating an exemplary antivibration mechanism inside the amplifier in accordance with the embodiment.

FIG. 31C is a fragmentary sectional view illustrating an exemplary antivibration mechanism inside the amplifier in accordance with the embodiment.

FIG. 32 is a perspective view illustrating a schematic configuration of the fourth and fifth amplifier units stacked on top of each other in accordance with the embodiment.

FIG. 33 is a perspective view illustrating a schematic configuration of a frame in accordance with the embodiment.

FIG. 34A is a top view of the frame shown in FIG. 33.

FIG. 34B is a front view of the frame shown in FIG. 33.

FIG. 34C is a side view of the frame shown in FIG. 33.

FIG. 35A is a top view illustrating the connection between the optical unit and the fourth and fifth amplifier units in accordance with the embodiment.

FIG. 35B is a front view illustrating the connection between the optical unit and the fourth and fifth amplifier units in accordance with the embodiment.

FIG. 35C is a side view illustrating the connection between the optical unit and the fourth and fifth amplifier units in accordance with the embodiment.

FIG. 35D is a rear view illustrating the connection between the optical unit and the fourth and fifth amplifier units in accordance with the embodiment.

FIG. 36A is a top view illustrating another connection between the optical unit and the fourth and fifth amplifier units in accordance with the embodiment.

FIG. 36B is a side view illustrating another connection between the optical unit and the fourth and fifth amplifier units in accordance with the embodiment.

FIG. 37 is a perspective view illustrating an exemplary configuration in which three amplifier units are stacked on top of one another in accordance with the embodiment.

FIG. 38 is a front view illustrating an exemplary configuration in which three amplifier units are stacked on top of one another in accordance with the embodiment.

FIG. 39 shows a maintenance procedure in accordance with the embodiment.

### DESCRIPTION OF PREFERRED EMBODIMENTS

Hereinafter, embodiments for implementing the present disclosure will be described in detail with reference to the accompanying drawings. In the subsequent description, each drawing merely illustrates shape, size, and positional relationship of members schematically to the extent that enables the content of the present disclosure to be understood. Accordingly, the present disclosure is not limited to the shape, the size, and the positional relationship of the members illustrated in each drawing. In order to simplify the drawings, a part of hatching along a section is omitted. Further, numerical values indicated hereafter are merely preferred examples of the present disclosure. Accordingly, the present disclosure is not limited to the indicated numerical values.

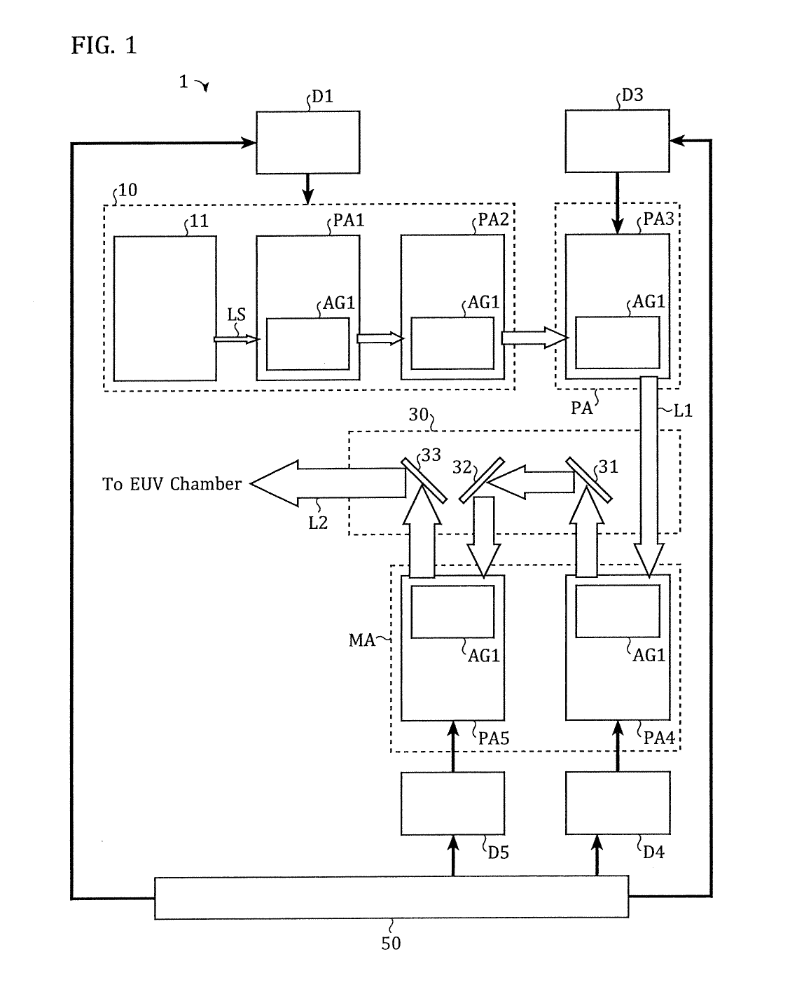

Hereinafter, a laser device, an extreme ultraviolet light generation device, and a method for maintaining the devices in accordance with an embodiment of the present disclosure will be described in detail with reference to the drawings. FIG. 1 is a block diagram illustrating a schematic configuration of the laser device in accordance with the embodiment. As shown in FIG. 1, a laser device 1 in accordance with the embodiment includes an oscillator (OSC) unit 10, a pre-amplifier PA, a multi-stage main amplifier MA, and an optical unit 30. Further, the laser device 1 includes an OSC power source D1, third through fifth power source units D3 through D5, and a switchboard 50. Each unit in the laser device 1 may require a laser gas, a purge gas, a gas for air valves, or a fluid for temperature control. In this case, the laser device 1 may further includes a gas/cooling medium distributor 60 (see, for example, FIG. 3) for distributing the above to each unit.

The OSC unit 10 outputs a pulsed laser beam as a seed beam LS. The pre-amplifier PA may include a third amplifier unit PA3 that amplifies the seed beam LS outputted from the OSC unit 10 and outputs the amplified beam as a laser beam L1. The multi-stage main amplifier MA may includes a fourth amplifier unit PA 4 and a fifth amplifier unit PA5 which amplify the laser beam L1 outputted from the pre-amplifier PA and outputs the amplified laser beam as a laser beam L2. The optical unit 30 propagates the laser beam L1 and the laser beam L2 outputted from the third through fifth amplifier units PA3 through PA5 to another amplifier (fourth and fifth amplifier units PA4 and PA5) or to a chamber (not shown). The OSC power source D1 and the third through fifth power source units D3 through D5 supply excitation energy to the OSC unit 10, the pre-amplifier PA, and the main amplifier MA respectively. The switchboard 50 distributes power to the OSC power source D1 and the third through fifth power source units D3 through D5.

Here, when CO₂ gas is used as a gain medium, applying a high voltage between electrodes in a gas containing CO₂ gas provides the excitation energy. When the high voltage is applied between the electrodes, an electric discharge occurs between the electrodes. This causes the CO₂ gas to be excited. Note that a radio-frequency voltage may be applied between electrodes to cause an RF discharge in CO₂ gas. Further, in the case of a TEA-CO₂ laser, a high-voltage pulse may be applied between electrodes.

The OSC unit 10 is an integrated unit of a master oscillator 11, a first amplifier PA1, and a second amplifier PA2. The master oscillator 11 outputs a laser beam having a specified wavelength as the seed beam LS. The first amplifier PA1 and the second amplifier PA2 amplify the seed beam LS outputted from the master oscillator 11.

The master oscillator 11 of the OSC unit 10 oscillates the seed beam LS in a single-longitudinal mode or in a multi-longitudinal mode with electrical energy supplied from the OSC power source D1. The seed beam LS may determine a pulse width and a repetition rate at each of the amplifiers (PA1 through PA5) disposed downstream thereof. Note that each wavelength component contained in the seed beam LS corresponds to at least any one of the gain bands in the amplifiers (PA1 through PA5). As the master oscillator 11 capable of outputting such seed beam LS includes a semiconductor laser such as a quantum cascade laser, a CO₂ gas laser, and a solid-state laser.

The first amplifier PA1 and the second amplifier PA2 sequentially amplify the seed beam LS having a specified wavelength outputted from the master oscillator 11. The seed beam LS outputted from the second amplifier PA2 of the OSC unit 10 enters the pre-amplifier PA disposed downstream thereof. The third amplifier unit PA3 of the pre-amplifier PA amplifies the seed beam LS outputted from the OSC unit 10. The amplified seed beam LS is outputted from the pre-amplifier PA as the laser beam L1.

The laser beam L1 outputted from the pre-amplifier PA enters the main amplifier MA that is disposed downstream thereof via the optical unit 30, for example. Note that the optical unit 30 may, for example, include, aside from high reflective mirrors 31 through 33, a partial reflective mirror, an off-axis paraboloidal mirror, a saturable absorber, a wavefront correction unit, a beam quality measuring device, and so forth (not shown). The saturable absorber absorbs a laser beam returning from the chamber or a laser beam oscillated by parasitic oscillation or self-induced oscillation at the main amplifier MA. This can prevent the pre-amplifier PA or the OSC unit 10 from being damaged. The wavefront correction unit expands and adjusts the beam profile of the laser beam L1 so that the laser beam L1 has a beam angle and a wavefront curvature that are suited to those of a laser beam that would be amplified efficiently in the main amplifier MA. As described above, providing the optical unit 30 with the saturable absorber, the wavefront correction unit, or the like makes it possible to correct the wavefront of a laser beam to be amplified. This can improve amplification efficiency at the main amplifier MA, for example. As a result, a high-power laser beam L2 can be obtained.

The laser beam L1 propagated to the main amplifier MA via the optical unit 30 is first amplified in the fourth amplifier unit PA4. The laser beam L1 amplified in the fourth amplifier unit PA4 is then amplified in the fifth amplifier unit PA5. As a result, the laser beam L2 of a single traverse mode, with a wavelength of 10.6 μm, energy in a range of 100 to 200 mJ, power in a range of 10 to 20 kW, is outputted from the fifth amplifier unit PA5. The laser beam L2, for example, is a pulsed laser beam having the repetition rate of 100 kHz.

The laser beam L2 outputted from the fifth amplifier unit PA5 is propagated to the chamber via the optical unit 30, for example, and thereafter strikes a target material supplied into the chamber. With this, the target material struck by the laser beam L2 is excited and turned into plasma. This plasma emits EUV light. Such chamber may be disposed in a room upstairs on the installation space 100 (see, for example, FIG. 3) in which the laser device 1 is installed.

Each of the amplifiers (PA1 through PA5) includes an amplification region which is filled with a CO₂ gas gain medium AG1 containing at least CO₂ gas. A predetermined potential difference is applied to the amplification region by high-frequency power supplied from each of the OSC power source D1 and the third through fifth power source units D3 through D5 connected to each amplifier (PA through PA5). The seed beam LS and the laser beam L1 are amplified as they pass through the amplification regions provided with the predetermined potential difference.

When the master oscillator 11 is configured of a semiconductor laser, for example, the OSC unit 10 is preferably provided with a current control actuator (not shown). The current control actuator generates a current signal for oscillating the master oscillator 11, and the current signal is inputted into the master oscillator 11. In this way, when the master oscillator 11 is configured of a semiconductor laser, controlling a waveform or an amount of current supplied to the semiconductor laser using the current control actuator makes it possible to control a pulse width, a waveform, intensity, or a repetition rate of the seed beam LS outputted from the master oscillator 11 with ease. As a result, a desired laser beam can easily be obtained.

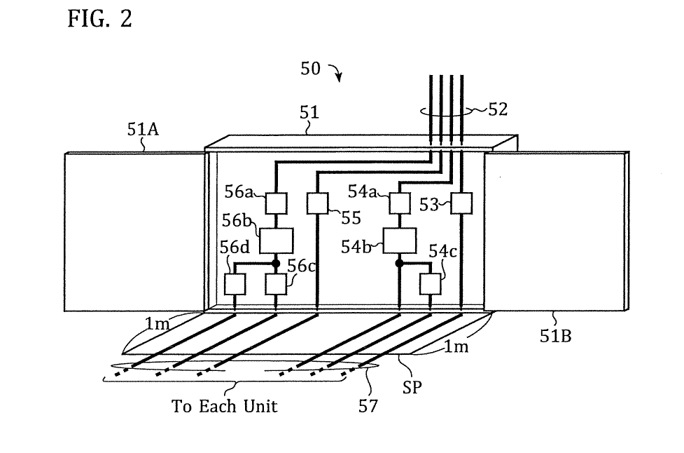

In the above-described configuration, power is distributed to the OSC power source D1 and the third through fifth power source units D3 through D5 via the switchboard 50. Here, FIG. 2 illustrates an exemplary configuration of the switchboard in accordance with the embodiment. As shown in FIG. 2, the switchboard 50 is accommodated in an cabinet 52 accessible through double door 51A and 51B. The cabinet 51 also accommodates transformers 54b and 56b, circuit breakers 53, 54a, 54c, 56a, 56c, and 56d, a contactor (not shown), and the like. The switchboard 50 is supplied with power from an external facility or the like via wiring 52. The power supplied from an external facility undergoes a boost in the voltage appropriately through the transformers 54b and 56b provided on the wiring 52 corresponding to each power source (D1, D3 through D5). Subsequently, the power which has undergone the boost in the voltage is supplied to each power source (D1, D3 through D5) via wiring 57. Each power source (D1, D3 through D5) boosts and modulates the voltage of the power supplied via the wiring 57 to a predetermined voltage. The boosted/modulated power is supplied to each amplifier (PA1 through PA5).

A work space SP needs to be secured in front of the switchboard 50 (double door 51A and 51B), in which an operation such as turning off a circuit breaker at maintenance is carried out (see, for example, NFPA 70 (National Electrical Code)). In the description to follow, for the sake of simplicity, the required work space SP has a width of 1 m. A space (room) in which the laser device 1 is installed, however, is limited in size (in terms of floor area and volume). Thus, there may be a case where it is difficult to accommodate all the units in a given space while securing the work space having a width of 1 m in front of the switchboard 50. In particular, when each unit is increased in size in order to achieve high throughput and high output power, it may be very difficult to accommodate the laser device 1 in the installation space 100, which is limited in size, while securing a work space for carrying out the maintenance work on each unit.

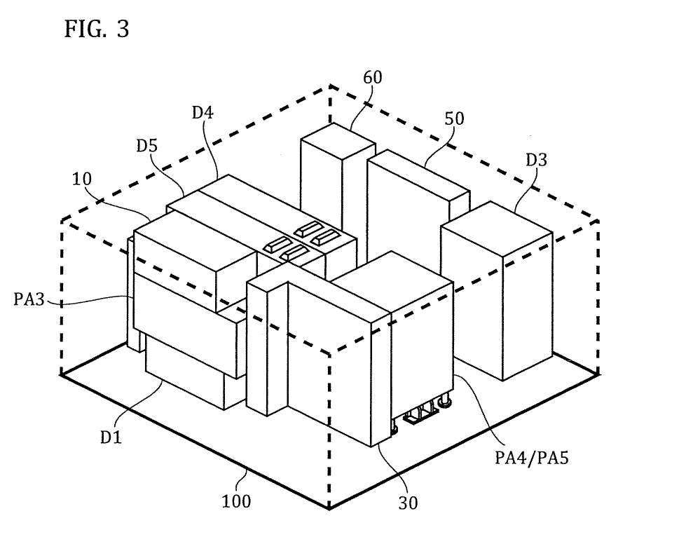

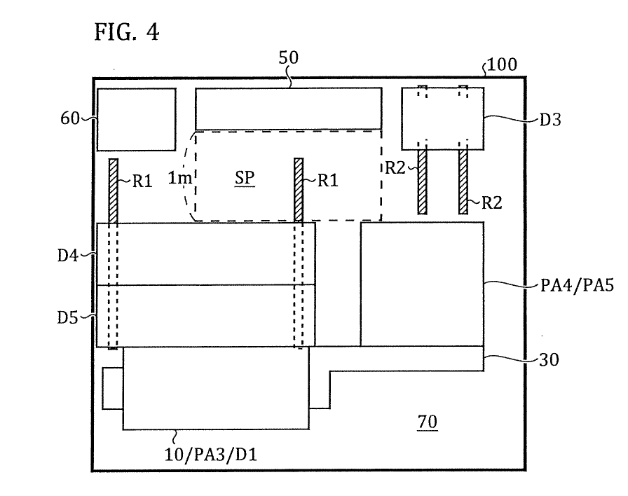

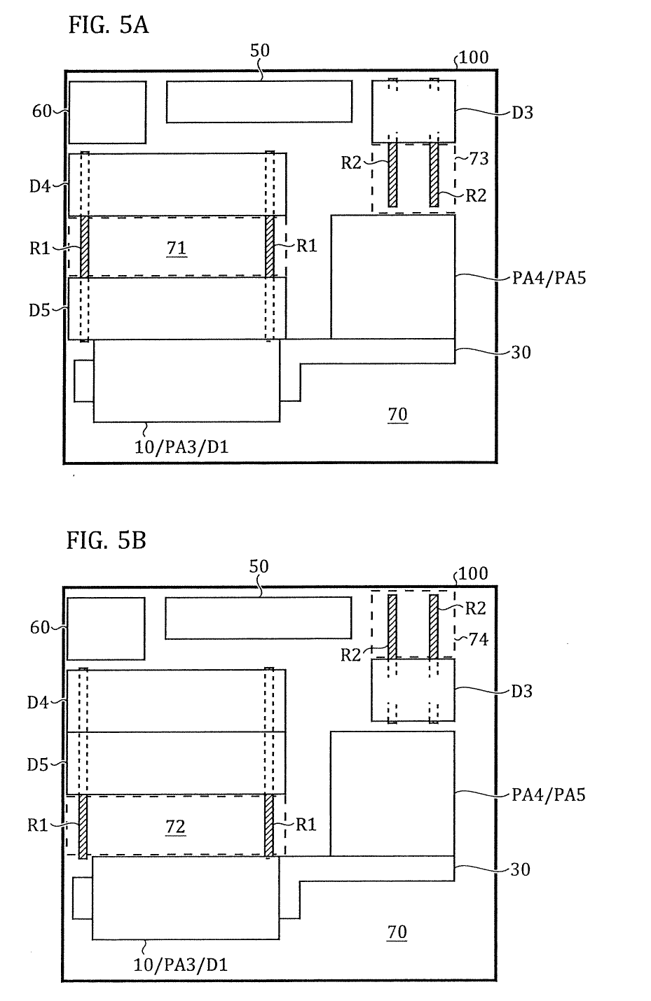

Therefore, in the embodiment, at least units that are disposed in front of the switchboard 50 are made movable. This makes it possible to move these units around within an unoccupied space in the installation space 100. As a result, the work space SP can be secured as needed in front of the switchboard 50. Hereinafter, this will be described in detail with reference to the drawings. FIG. 3 is a perspective view illustrating an exemplary layout of the laser device, which is in operation, accommodated in the installation space in accordance with the embodiment. FIG. 4 is a top view illustrating an exemplary layout of the laser device, which is in operation, accommodated in the installation space in accordance with the embodiment. FIG. 5A is a top view illustrating an exemplary layout of the laser device, which is under maintenance, accommodated in the installation space in accordance with the embodiment. FIG. 5B is a top view illustrating another exemplary layout of the laser device, which is under maintenance, accommodated in the installation space in accordance with the embodiment.

In the exemplary layouts shown in FIGS. 3 through 5B, the switchboard 50, the gas/cooling medium distributor 60, the OSC power source D1, and the fourth amplifier unit PA4, for example, are anchored onto the floor in the installation space 100. The optical unit 30 as well is anchored onto the floor in the installation space 100. Without being limited thereto, however, the optical unit 30 may be anchored onto the third amplifier unit PA3, or it may be anchored onto the fourth amplifier unit PA4 and onto the fifth amplifier unit PA5 stacked on top of the fourth amplifier unit PA4.

The OSC unit 10, the third amplifier unit PA3, and the OSC power source D1 may be stacked on top of one another. Similarly, the fourth amplifier unit PA4 and the fifth amplifier unit PA5 may be stacked on top of each other. Stacking each unit on top of each other helps to minimize the total floor space of the laser device 1.

In the exemplary layout, the OSC unit 10, the third amplifier unit PA3, the OSC power source D1, the optical unit 30, the fourth amplifier unit PA4, the fifth amplifier unit PA5, and the third power source unit D3 are arranged so as to surround the fourth power source unit D4 and the fifth power source unit D5. Further, secured in the installation space 100 is a work space 70 for carrying out the maintenance work on such units as the OSC unit 10, the third amplifier unit PA3, the OSC power source unit D1, the optical unit 30, the fourth amplifier unit PA4, the fifth amplifier unit PA5, and the third power source unit D3.

In the embodiment, the fourth power source unit D4 and the fifth power source unit D5 are disposed in front of the switchboard 50. The fourth power source unit D4 and the fifth power source unit D5 are movable in a direction perpendicular to the work surface, which is the side accessible through the doors 51A and 51b, of the switchboard 50. The work space SP secured in front of the switchboard 50 will have a width of at least 1 m as described above when the fourth power source unit D4 and the fifth power source unit D5 are spaced farthermost from the work surface of the switchboard 50. As a result, as shown in FIG. 4, the work space SP having a width of 1 m can be secured in front of the switchboard 50 when the maintenance work is carried out.

A caster (not shown) and two rails installed on the floor of the installation space 100 extending in a direction perpendicular to the work surface of the switchboard 50 enable the fourth power source unit D4 and the fifth power source unit D5 to be moved. When the maintenance work is carried out on parts or the like inside the fourth power source unit D4 or the fifth power source unit D5 with the covers thereof located to face each other opened, the fourth power source unit D4 is moved toward the switchboard 50 along the rails R1, as shown in FIG. 5A. This secures a work space 71 between the fourth power source unit D4 and the fifth power source unit D5. Further, when the maintenance work is carried out on parts or the like inside the fifth power source unit D5, the OSC unit 10, the third amplifier unit PA3, or the OSC power source D1 (hereinafter, the OSC unit 10, the third amplifier unit PA3, and the OSC power source D1 will be referred to as an OSC unit 10 group) with the covers thereof located to face one another opened, the fourth power source unit D4 and the fifth power source unit D5 are slid along the rails R1 toward the switchboard 50, as shown in FIG. 5B. This secures a work space 72 between the fifth power source unit D5 and the OSC unit 10 group.

Similarly, rails R2 may also be provided on the floor for sliding the third power source unit D3. As can be seen in FIGS. 5A and 5B, this enables to secure work spaces 73 and 74 for carrying out the maintenance work on the third power source unit D3.

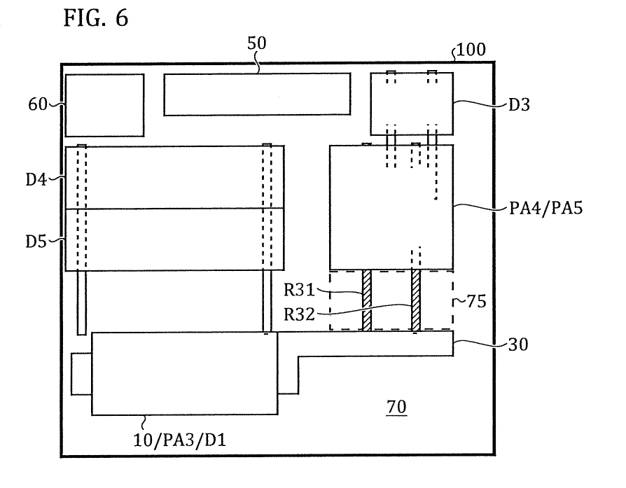

In the examples shown in FIGS. 4 through 5B, the third through fifth power source units D3 through D5 are movable. The present disclosure, however, is not limited thereto. As shown in FIG. 6, for example, the configuration may be such that the fourth amplifier unit PA4 and the fifth amplifier unit PA5, which are stacked on top of each other, are movable with casters (not shown) and rails R31 and R32, similarly as in the case of the fourth power source unit D4, for example. This makes it possible to secure a work space 75 as needed between the fourth and fifth amplifier units PA4 and PA5 and the optical unit 30. Note that FIG. 6 is a top view illustrating another exemplary layout of the laser device accommodated in the installation space in accordance with the embodiment.

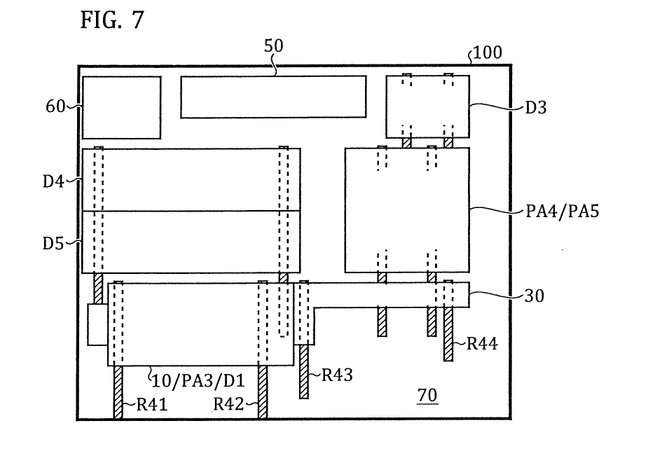

Further, as shown in FIG. 7, for example, the configuration may be such that the OSC unit 10, the third amplifier unit PA3, and the OSC power source unit D1, which are stacked on top of one another, and the optical unit 30 are movable respectively with casters (not shown) and rails R41 and R42 and casters (not shown) and rails R43 and R44, similarly as in the case of the fourth power source unit D4. This makes it possible to secure a work space as needed between a wall and each unit even when the OSC unit 10, the third amplifier unit PA3, and the OSC power source unit D1 are disposed close to the wall of the installation space 100. Also, the above configuration makes it possible to secure a work space as needed between a wall and the optical unit 30 even when the optical unit 30 is disposed closed to the wall of the installation space 100. As a result, the laser device 1 can be accommodated in an even smaller space. Note that FIG. 7 is a top view illustrating another exemplary layout of the laser device accommodated in the installation space in accordance with the embodiment.

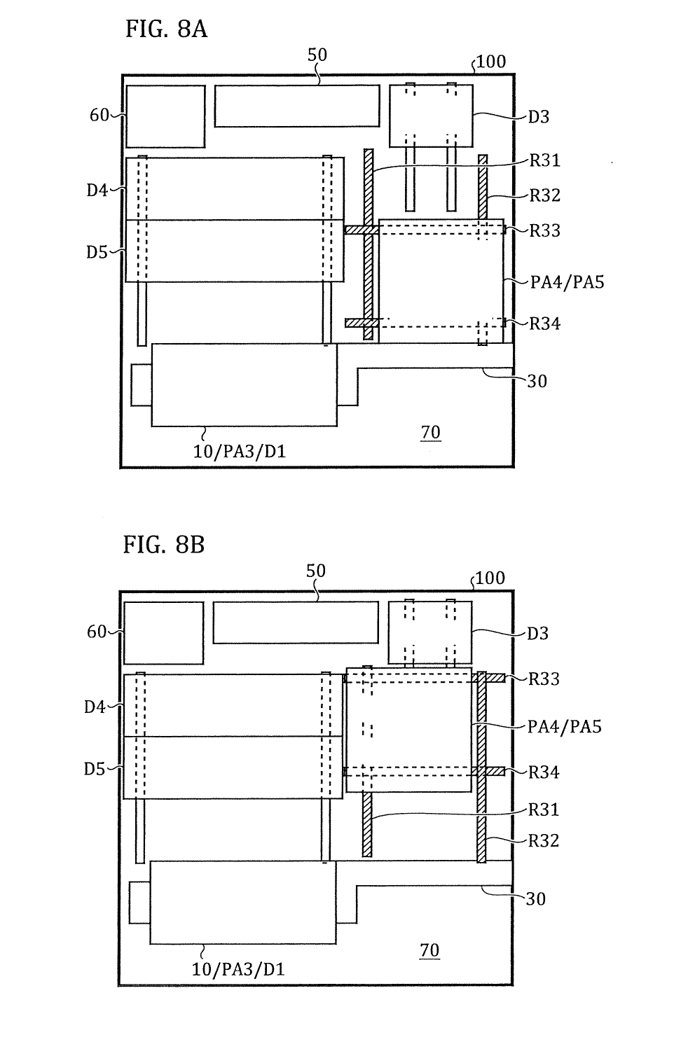

Further, as shown in FIGS. 8A and 8B, for example, the configuration may be such that each unit accommodated inside the installation space 100 (the fourth amplifier unit PA4 and the fifth amplifier unit PA5 which are stacked on top of each other will be exemplified below) is movable two-dimensionally with a two-dimensional movement mechanism configured of the rails R31 and R32 and the rails R33 and R34, which cross over each other. Note that FIG. 8A is a top view illustrating another exemplary layout of the laser device accommodated in the installation space in accordance with the embodiment. FIG. 8B is a top view illustrating another exemplary layout of the laser device accommodated in the installation space in accordance with the embodiment.

As shown in FIGS. 8A and 8B, the rails R33 and R34 are each provided with a caster, for example. The rails R33 and R34 can be moved along the rails R31 and R32 (vertical direction in the figure) with the casters placed on the rails R31 and R32. Further, the fourth amplifier unit PA4 and the fifth amplifier unit PA5 are each provided with a caster as well. The casters are placed on the rails R33 and R34, whereby the fourth amplifier unit PA4 and the fifth amplifier unit PA5 can be moved along the rails R33 and R34 (horizontal direction in the figure).

Such configuration makes it possible to secure a work space as needed between a wall and each unit even when each unit is disposed close to the wall in the installation space 100.

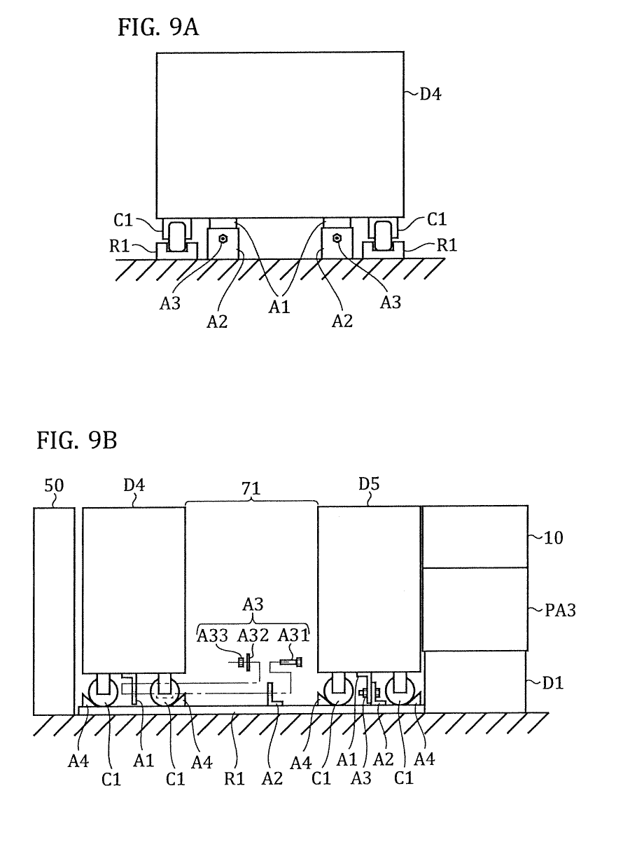

Referring now to FIGS. 9A and 9B, a movement mechanism for the fourth power source unit D4 and the fifth power source unit D5 using the rails R1 in accordance with the embodiment will be described in detail. FIG. 9A is a side view of the fourth power source unit and the movement mechanism viewed in a direction of the movement thereof in accordance with the embodiment. FIG. 9B is a side view of the fourth power source unit, the fifth power source unit, and the movement mechanism viewed in a direction perpendicular to the direction of the movement thereof in accordance with the embodiment. Note that the movement mechanism for the fifth power source unit D5 is similar to the movement mechanism for the fourth power source unit D4; therefore, the fourth power source unit D4 will be described in FIG. 9A. Further, FIG. 9B illustrates a state where the fourth power source unit D4 is slid toward the switchboard 50 and the fifth power source unit D5 is slid toward the OSC unit 10 group. Furthermore, the movement mechanism for the third power source unit D3 using the rails R2 is similar to that for the fourth power source unit D4 or the fifth power source unit D5; therefore, detailed description thereof will be omitted here.

As shown in FIGS. 9A and 9B, rotatable casters C1 are provided on a bottom surface of the fourth power source unit D4 at four corners thereof. Each caster C1 rotates while being fitted in a groove in the rail R1. With this, the fourth power source unit D4 supported by the casters C1 moves along the rails R1. Similarly, the rotatable casters C1 are also provided on a bottom surface of the fifth power source unit D5 at four corners thereof, for example. With this, the fifth power source unit D5 supported by the casters C1 moves along the rails R1. For example, when only the fourth power source unit D4 is slid toward the switchboard 50 from the state in which the device is in operation (see FIG. 4), the work space 71 is secured between the fourth power source unit D4 and the fifth power source unit D5, as shown in FIG. 9B.

L-shaped fittings A1 are anchored onto the bottom surface of the fourth power source unit D4. Further, stoppers A2 which come in contact with the L-shaped fittings A1 are anchored onto a floor surface of the installation space 100 at a location where the fourth power source unit D4 is disposed while the device is in operation. The stopper A2 is made of metal, for example, and functions as a positioning member. As the fourth power source unit D4 is slid toward the OSC unit 10 group along the rails R1, the L-shaped fitting A1 and the stopper A2 makes contact with each other at a location where the fourth power source unit D4 is disposed while the device is in operation. With this, the fourth power source unit D4 is positioned at a predetermined location. Similarly, the L-shaped fittings A1 are anchored onto the bottom surface of the fifth power source unit D5. In addition, the stoppers A2 which come in contact with the L-shaped fittings A1 are anchored onto a floor surface of the installation space 100 at a location where the fifth power source unit D5 is disposed while the device is in operation. As the fifth power source unit D5 is slid toward the OSC unit 10 group along the rails R1, the L-shaped fittings A1 and the stoppers A2 make contact with each other at a location where the fifth power source unit D5 is disposed while the device is in operation. With this, the fifth power source unit D5 is positioned at a predetermined location.

The L-shaped fitting A1 and the stopper A2 are provided with through-holes respectively that communicate with each other when the L-shaped fitting A1 and the stopper A2 make contact with each other. The through-holes are for fitting a fixture A3 therein for fixing the L-shaped fitting A1 and the stopper A2 in a state where they are in contact with each other. General-purpose parts such as a bolt A31, a washer A32, and a nut A33 may be used for the fixture A3. Fixing the L-shaped fitting A1 anchored onto the bottom surface of the unit and the stopper A2 anchored onto the floor with the fixture A3 enables each of the fourth power source unit D4 and the fifth power source unit D5 to be anchored to a predetermined position. As a result, the fourth power source unit D4 and the fifth power source unit D5 can be prevented from moving while they are in operation, for example. Further, the fourth power source unit D4 and the fifth power source unit D5 can also be prevented from falling even when an earthquake or the like occurs. That is, the L-shaped fitting A1, the stopper A2, and the fixture A3 function not only as a positioning member for the fourth power source unit D4 and the fifth power source unit D5 but as an earthquake resistant fixture as well. In order to anchor the fourth power source unit D4 and the fifth power source unit D5 even more securely, a tirestop A4 may be provided so that the casters C1 do not move on the rails R1.

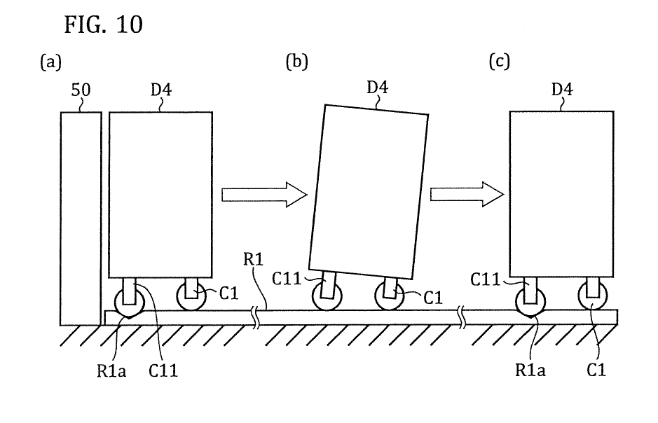

Further, as shown in FIG. 10, the fourth power source unit D4 and the fifth power source unit D5 may be positioned using recesses provided on the rail R1. FIG. 10 illustrates the fourth power source unit and the movement mechanism in accordance with a modification of the embodiment. Here, FIG. 10 is a side view of the fourth power source unit viewed in a direction perpendicular to the direction of the movement. Note that in FIG. 10, for the sake of simplicity, the fifth power source unit D5 and a mechanism for positioning the fifth power source unit D5 are not depicted. As shown in FIG. 10, in the modification, of the plurality of the casters C1 for the fourth power source unit D4, casters C11 at the side of the switchboard 50 or the side of the OSC unit 10 group have a bearing that is longer than that of the other casters C1. Here, the bearing is a member for supporting a rotational axis of a wheel in a caster. Further, V-shaped or recessed grooves R1a are provided at predetermined positions on the rails R1 in order to position the fourth power source unit D4 to the switchboard 50 side. Similarly, V-shaped or recessed grooves R1a are provided at predetermined positions in order to position the fourth power source unit D4 to the OSC unit 10 group side. The bearing of the caster C11 is longer than the bearing of the caster C1 by the depth of the groove R1a. Accordingly, when the casters C11 having the longer bearing are fitted in the grooves R1a, the fourth power source unit D4 is positioned while it is held horizontally.

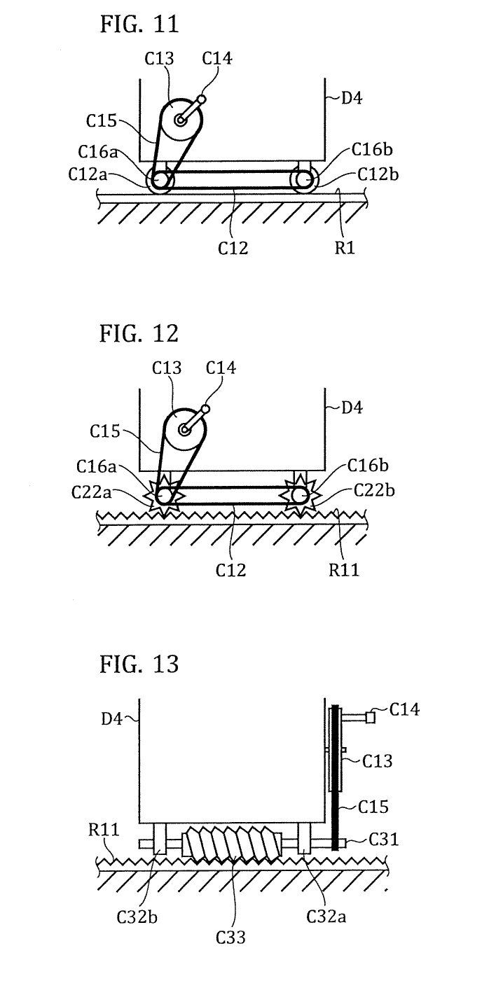

The fourth power source unit D4 and the fifth power source unit D5 may respectively be provided with movement assist mechanisms for assisting the movement thereof. Here, referring to FIGS. 11 through 13, an exemplary configuration of the movement assist mechanism in accordance with the embodiment will be described in detail. FIG. 11 is a side view illustrating a first exemplary configuration of the movement assist mechanism in accordance with the embodiment. FIG. 12 is a side view illustrating a second exemplary configuration of the movement assist mechanism in accordance with the embodiment. FIG. 13 is a side view illustrating a third exemplary configuration of the movement assist mechanism in accordance with the embodiment.

As shown in FIG. 11, in the first exemplary configuration of the movement assist mechanism in accordance with the embodiment, the fourth power source unit D4 is manually movable. Specifically, the movement assist mechanism of the first exemplary configuration includes: a disc C13 and a handle C14 mounted on a side surface of the fourth power source unit D4; and a roller C16a provided at least to one caster C1 of the fourth power source unit D4. The disc C13 is provided on the side surface of the fourth power source unit D4 such that it is rotatable about an axis perpendicular to the direction into which the rail R1 extends. The handle C14 is configured to allow the disc C13 to be manually rotated and is anchored onto the disc C13. The roller C16a is anchored onto a rotational shaft of a tire C12a in the caster C1. A belt C15 is wound around the disc C13 and the roller C16a. The rotative force provided to the disc C13 by the handle C14 is transmitted to the roller C16a via the belt C15. This causes the fourth power source unit D4 to move. Further, the rotative force generated to the tire C12a may be transmitted to a tire C12b of the caster C1 placed on the rail R1 on which the tire C12a is placed as well. In this case, a roller C16b is anchored onto the tire C12b, and a belt C12 is wound around the rollers C16a and C16b.

Further, as shown in FIG. 12, the second exemplary configuration of the movement assist mechanism in accordance with the embodiment is similar to the first exemplary configuration. However, the rail R1 in the first exemplary configuration is replaced by a slide gear rail R11 having regularly arranged concavities and convexities formed on the upper surface thereof. In addition, the tires C12a and C12b of each caster C1 are replaced by gears C22a and C22b respectively which fit with the concavities and convexities of the slide gear rail R11. With this configuration, as in the case of the first exemplary configuration, the rotative force generated as the handle C14 is manually rotated is transmitted to the gear C22a via the belt C15. This causes the fourth power source unit D4 to move. Note that the gears C22a and C22b and the slide gear rail R11 may be provided only to one side of the fourth power source unit D4.

Further, as shown in FIG. 13, in the third exemplary configuration of the movement assist mechanism in accordance with the embodiment, the disc C13 and the handle C14, for example, are provided on a side surface of the fourth power source unit D4 so as to be rotatable about an axis parallel with the direction into which the rail R1 extends. Further, the rail R1 is replaced by the slide gear rail R11. Furthermore, in place of more than one caster C1, all of which are placed on the same slide gear rail R11, a screw gear C33 with the rotational shaft thereof being parallel with the direction into which the slide gear rail R11 extends is provided on the bottom surface of the fourth power source unit D4. The rotational shaft C31 of the screw gear C33 is rotatably supported by bearings C32a and C32b provided on the bottom surface of the fourth power source unit D4. With this configuration, as in the case of the first and second exemplary configurations, the rotative force generated as the handle C14 is manually rotated is transmitted to the screw gear C33 via the belt C15. This causes the fourth power source unit D4 to move. Note that the screw gear C33 and the slide gear rail R11 may be provided only to one side of the fourth power source unit D4.

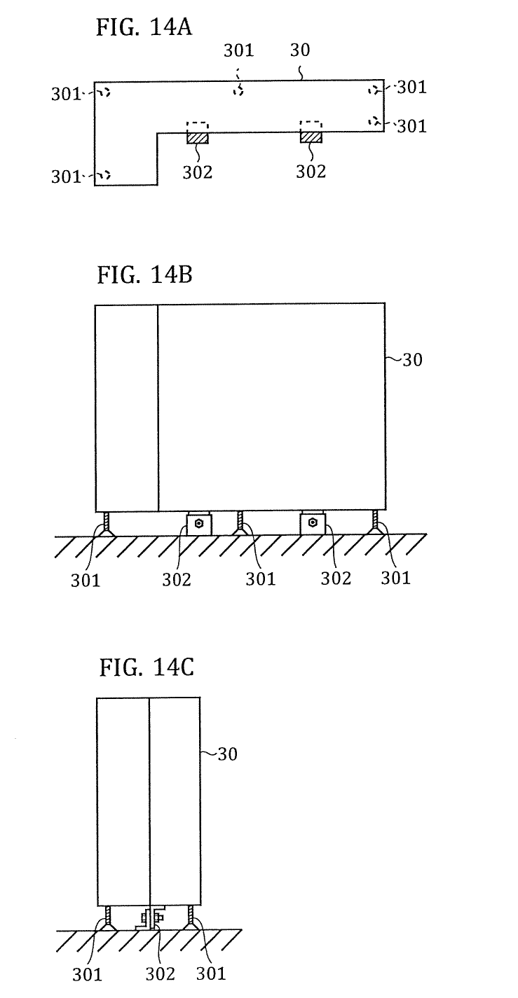

Next, the optical unit 30 in accordance with the embodiment will be described in detail with reference to the drawings. FIG. 14A is a top view illustrating an exemplary configuration of the optical unit anchored onto a floor surface in accordance with the embodiment. FIG. 14B is a side view illustrating the exemplary configuration of the optical unit anchored onto a floor surface in accordance with the embodiment. FIG. 140 is another side view illustrating the exemplary configuration of the optical unit anchored onto the floor surface in accordance with the embodiment.

As shown in FIGS. 14A through 14C, the optical unit 30 is disposed on a floor surface in the installation space 100 (see, for example, FIG. 3). At this time, level adjusters 301, of which the height can be adjusted independently, may preferably be used as support members for the optical unit 30. With this, the optical unit 30 can be supported to be held horizontally. Further, the optical unit 30 may be anchored onto the floor surface using an earthquake-resistive fixture 302 that is similar to the above-described earthquake-resistive fixture configured of the L-shaped fitting A1, the stopper A2, and the fixture A3.

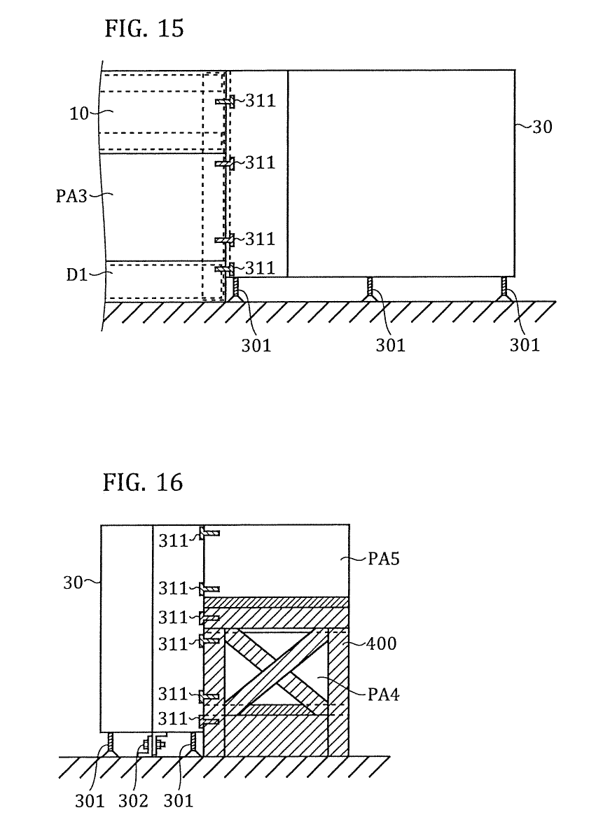

The optical unit 30 may, for example, be anchored onto the OSC unit 10 group, aside from the floor surface in the installation space 100, using bolts 311, as shown in FIG. 15. Further, as shown in FIG. 16, the optical unit 30 may be anchored onto the fourth and fifth amplifier units PA4 and PA5 using the bolts 311. At this time, the fourth and fifth amplifier units PA4 and PA5 may be stacked on top of each other with a frame 400. FIG. 15 is a side view illustrating an exemplary configuration of the optical unit anchored onto the OSC unit group in accordance with the embodiment. FIG. 16 is a side view illustrating an exemplary configuration of the optical unit anchored onto the fourth and fifth amplifier units in accordance with the embodiment.

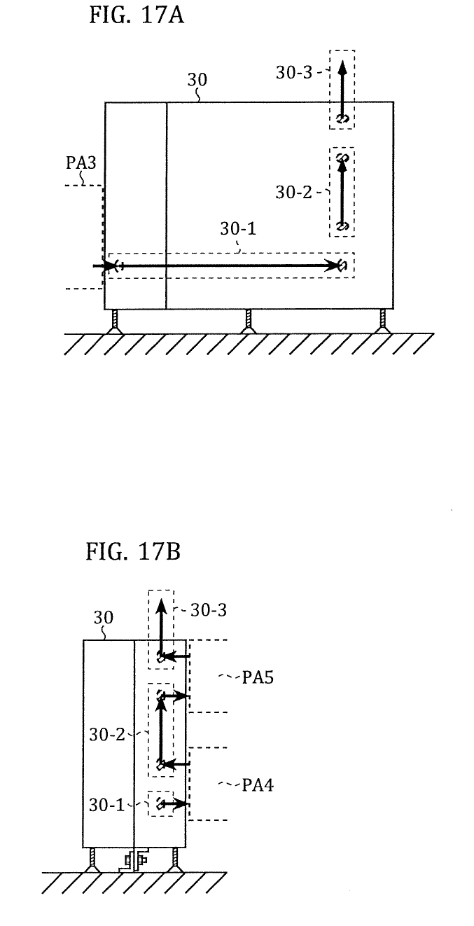

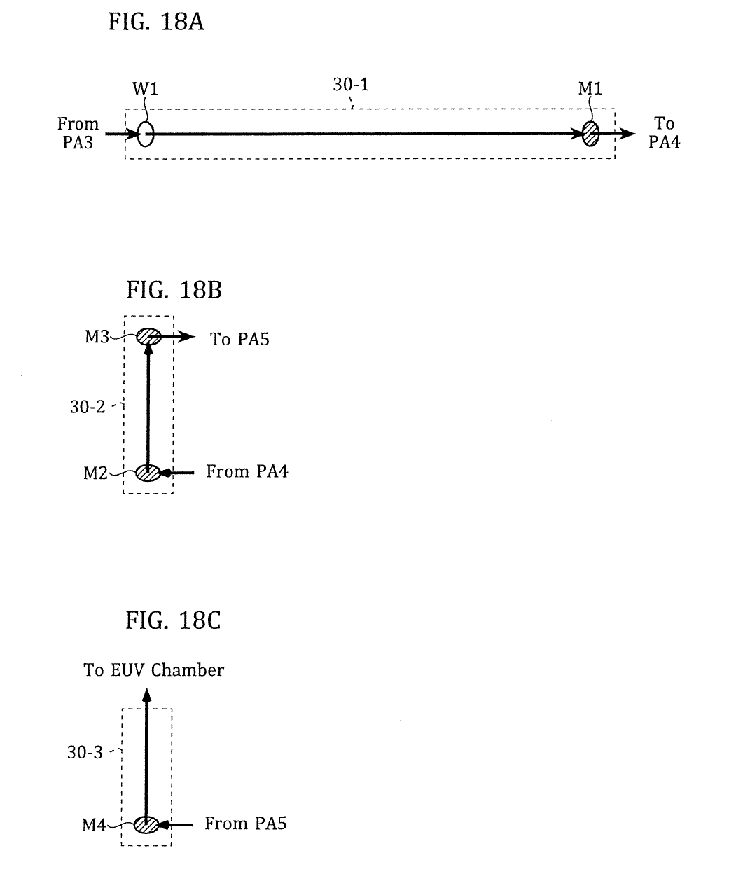

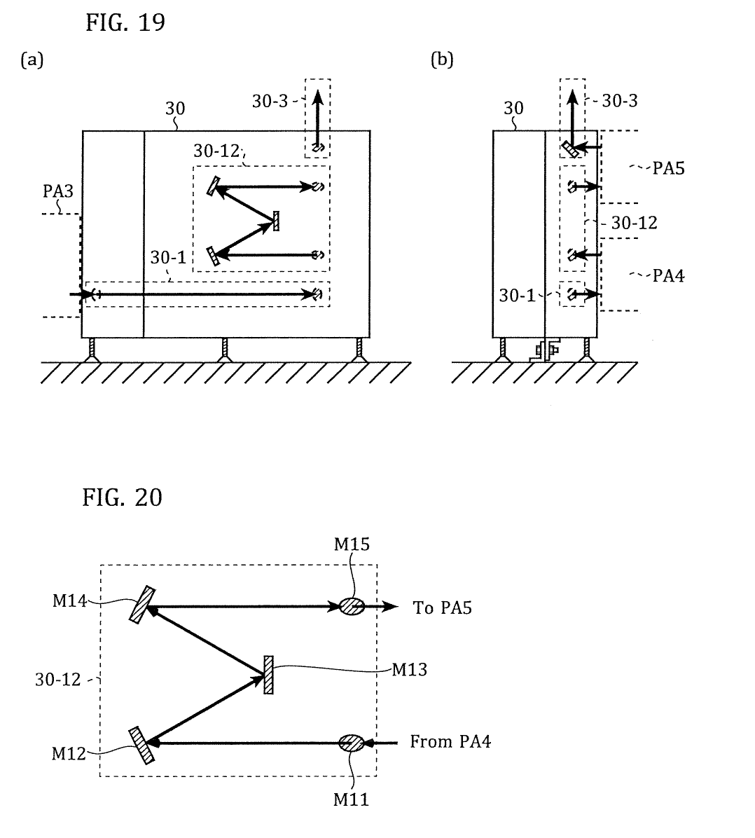

Subsequently, the configuration of the optical unit 30 in accordance with the embodiment will be described in detail with reference to the drawings. FIGS. 17A and 17B are side views illustrating a schematic configuration of the optical unit in accordance with the embodiment. FIG. 18A is a diagram illustrating an exemplary configuration of a first relay optical system in the optical unit in accordance with the embodiment. FIG. 18B is a diagram illustrating an exemplary configuration of a second relay optical system in the optical unit in accordance with the embodiment. FIG. 18C is a diagram illustrating an exemplary configuration of a third relay optical system in the optical unit in accordance with the embodiment.

As shown in FIGS. 17A and 17B, the optical unit 30 includes a first relay optical system 30-1, a second relay optical system 30-2, and a third relay optical system 30-3. The first relay optical system 30-1 guides a laser beam outputted from the third amplifier unit PA3 to the fourth amplifier unit PA4. The second relay optical system 30-2 guides a laser beam outputted from the fourth amplifier unit PA4 to the fifth amplifier unit PA5. The third relay optical system 30-3 guides a laser beam outputted from the fifth amplifier unit PA 5 to a chamber (not shown).

As shown in FIG. 18A, the first relay optical system 30-1 includes an input window W1 and an off-axis paraboloidal mirror M1. The input window W1 allows the laser beam outputted from the third amplifier unit PA3 to enter the optical system. The off-axis paraboloidal mirror M1 collimates the laser beam which has entered the first relay optical system 30-1 through the input window W1 and reflects the collimated laser beam toward the fourth amplifier unit PA4.

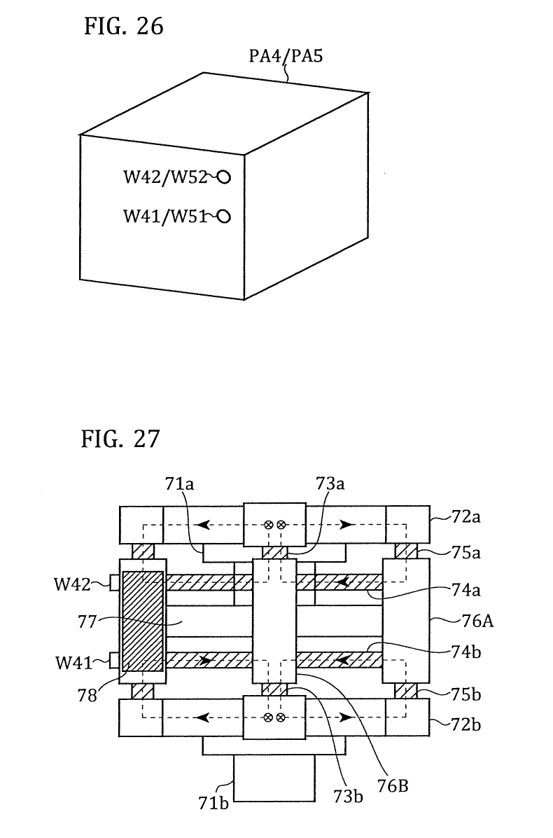

The off-axis paraboloidal mirror M1 may be replaced by an adaptive optics (AO). The laser beam reflected by the off-axis paraboloidal mirror M1 enters the fourth amplifier unit PA4 through an input window W41 (see FIG. 26) of the fourth amplifier unit PA4. The adaptive optics, for example, includes a deformable mirror, of which a focal distance can be adjusted freely. The deformable mirror, for example, may be deformed a shape of a mirror surface thereof such as a toroidal shape or a spherical shape, whereby the focal distance can be adjusted to a desired focal distance.

As shown in FIG. 18B, the second relay optical system 30-2, for example, includes a flat mirror M2 and an off-axis paraboloidal mirror M3. The flat mirror M2 reflects a laser beam outputted from the fourth amplifier unit PA4 through an output window W42 (see FIG. 26). The off-axis paraboloidal mirror M3 collimates the laser beam reflected by the flat mirror M2 and reflects the laser beam toward the fifth amplifier unit PA5 disposed on the fourth amplifier unit PA4. The off-axis paraboloidal mirror M3 may be replaced by an adaptive optics (AO). The laser beam reflected by the off-axis paraboloidal mirror M3 enters the fifth amplifier unit PA5 through an input window W51 (see FIG. 26) of the fifth amplifier unit PA5.

As shown in FIG. 18C, the third relay optical system 30-3, for example, includes an off-axis paraboloidal mirror M4. The off-axis paraboloidal mirror M4 collimates a laser beam outputted from the fifth amplifier unit PA5 through an output window W51 (see FIG. 26) and reflects the collimated laser beam toward the chamber (not shown). The off-axis paraboloidal mirror M4 may be replaced by a flat mirror. The laser beam reflected by the off-axis paraboloidal mirror M4 is then focused in a plasma generation region inside the chamber, where a target material arrives or passes. Note that the plasma generation region is a space which includes a position at which the target material is irradiated with a laser beam. Plasma which emits EUV light is generated in the plasma generation region.

The optical unit 30 in accordance with the embodiment may also be configured as shown in FIGS. 19 and 20. FIG. 19 is a side view schematically illustrating another configuration of the optical unit in accordance with the embodiment. FIG. 20 is a diagram illustrating another exemplary configuration of the second relay optical system in the optical unit in accordance with the embodiment. As shown in FIG. 19, in another exemplary configuration of the optical unit 30, the second relay optical system 30-2 is replaced by a second relay optical system 30-12. The second relay optical system 30-12, for example, includes flat mirrors M11 and M12, a spherical mirror M13, and flat mirror M14 and M15. The flat mirrors M11 and M12 reflect the laser beam outputted from the fourth amplifier unit PA4 through the output window W42. The spherical mirror M13 collimates the laser beam reflected by the flat mirror M12 and reflects the collimated laser beam. The flat mirrors M14 and M15 guide the laser beam reflected by the spherical mirror M13 toward the fifth amplifier unit PA5. The spherical mirror M13 may be replaced by an adaptive optics (AO). Further, the off-axis paraboloidal mirror M1 in the first relay optical system 30-1 may be replaced by a flat mirror, and the off-axis paraboloidal mirror M4 in the third relay optical system 30-3 may be replaced by a flat mirror, as well.

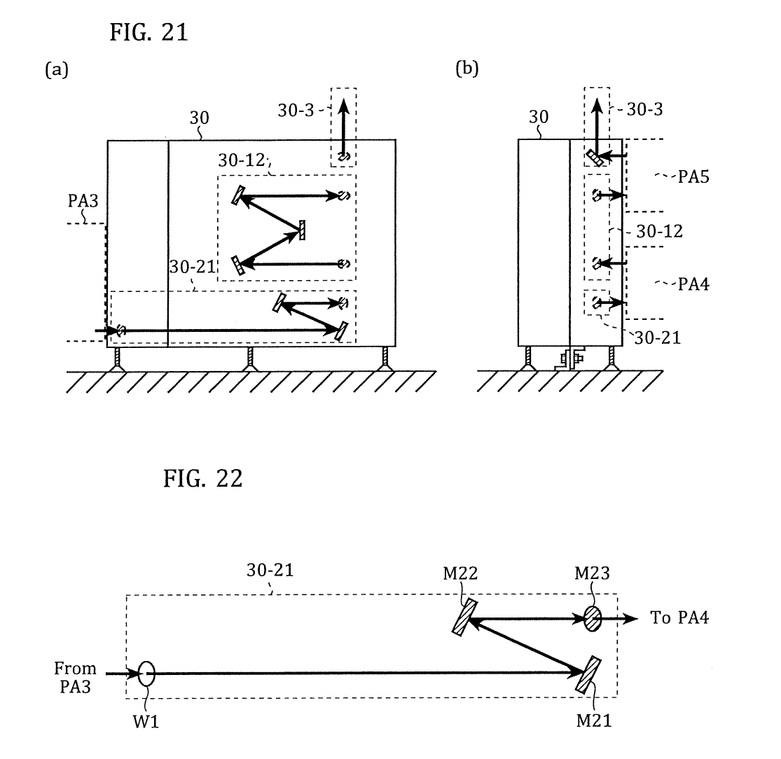

The optical unit 30 in accordance with the embodiment may be configured as shown in FIGS. 21 and 22, as well. FIG. 21 is a side view schematically illustrating another configuration of the optical unit in accordance with the embodiment. FIG. 22 is a diagram illustrating another exemplary configuration of the first relay optical system in the optical unit in accordance with the embodiment. As shown in FIG. 21, in another exemplary configuration of the optical unit 30, the first relay optical system 30-1 is replaced by a first optical system 30-21. The first relay optical system 30-21, for example, includes a flat mirror M21, a spherical mirror M22, and a flat mirror M23. The flat mirror M21 reflects the laser beam, which has entered the first relay optical system 30-21 through the input window W1, outputted from the third amplifier unit PA3. The spherical mirror M22 collimates the laser beam reflected by the flat mirror M21 and reflects the collimated laser beam. The flat mirror M23 reflects the laser beam reflected by the spherical mirror M22 toward the fourth amplifier unit PA4. The spherical mirror M22 may be replaced by an adaptive optics (AO). Further, the second relay optical system 30-12 shown in FIG. 20 may be used for the second relay optical system. In this case, an adaptive optics (AO) may be used in place of the flat mirror M11.

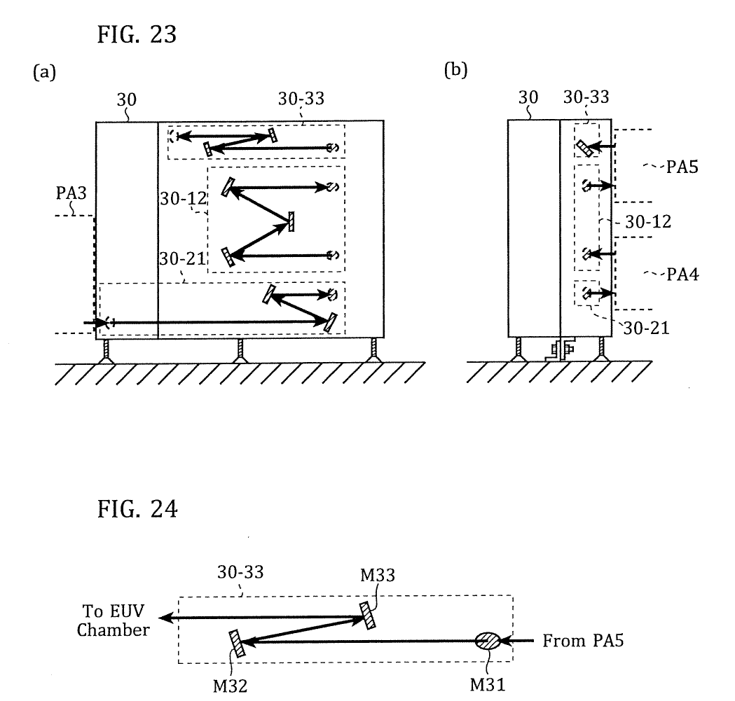

Furthermore, the optical unit 30 in accordance with the embodiment may be configured as shown in FIGS. 23 and 24. FIG. 23 is a side view schematically illustrating another configuration of the optical unit in accordance with the embodiment. FIG. 24 is a diagram illustrating another exemplary configuration of the third relay optical system in the optical unit in accordance with the embodiment. As shown in FIG. 23, in another exemplary configuration of the optical unit 30, the third relay optical system 30-3 is replaced by a third relay optical system 30-33. The third relay optical system 30-33, for example, includes flat mirrors M31, M32, and M33. The flat mirrors M31, M32, and M33 guide a laser beam outputted from the fifth amplifier unit PA5 through an output window W52 toward the chamber.

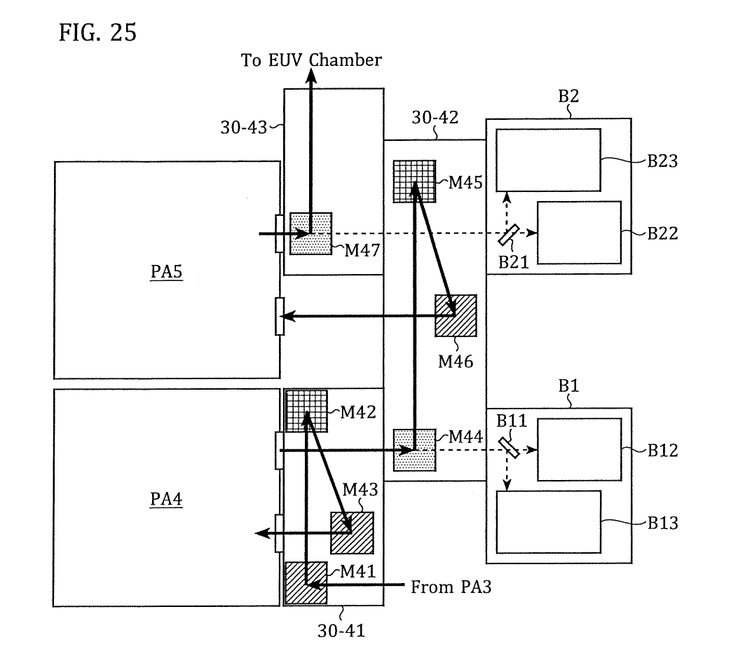

The optical unit 30 in accordance with the embodiment may be configured to monitor the beam intensity of the laser beam outputted from the fourth amplifier unit PA4 and the fifth amplifier unit PA5. In this case, the mirrors (corresponding to flat mirrors M2 and M11) for reflecting the laser beam to be monitored which is outputted from the fourth amplifier unit PA4 are replaced by beam splitters. Similarly, the mirrors (corresponding to off-axis paraboloidal mirror M4 and flat mirror M31) for reflecting the laser beam outputted from the fifth amplifier unit PA5 are replaced by beam splitters, as well. Here, an exemplary configuration for monitoring outputs from the fourth amplifier unit and the fifth amplifier unit in accordance with the embodiment is shown in FIG. 25.

As shown in FIG. 25, the configuration for monitoring the outputs from the fourth amplifier unit and the fifth amplifier unit includes a first relay optical system 30-41 configured of a flat mirror M41, an adaptive optics (AO) M42, and a flat mirror M43. The first optical system 30-41 guides the laser beam outputted from the third amplifier unit PA3 toward the fourth amplifier unit PA4.

In addition, the monitoring configuration shown in FIG. 25, for example, includes a second relay optical system 30-42 configured of a beam splitter M44, an adaptive optics (AO) M45, and a flat mirror M46. The beam splitter M44 transmits part of the laser beam outputted from the fourth amplifier unit PA4 and reflects part of the laser beam. The adaptive optics (AO) guides the laser beam reflected by the beam splitter M44 toward the fifth amplifier unit PA5.

The monitoring configuration shown in FIG. 25, for example, further includes a third relay optical system 30-43 configured of a beam splitter M47. The beam splitter M47 transmits part of the laser beam outputted from the fifth amplifier unit PA5 and reflects part of the laser beam toward the chamber.

The monitoring configuration shown in FIG. 25, for example, further includes a monitor box B1 and a monitor box B2. The monitor box B1 monitors the laser beam transmitted through the beam splitter M44 of the second relay optical system 30-42. The monitor box B2 monitors the laser beam transmitted through the beam splitter M47 of the third relay optical system 30-43.

Part of the laser beam transmitted through the beam splitter M44 of the second relay optical system 30-42 is transmitted through a beam splitter B11 provided at an input stage of the monitor box B1 and thereafter enters an output monitor B12. The output monitor B12 measures the intensity of the incident laser beam. With this, the output monitor B12 detects the intensity (energy) of the laser beam outputted from the fourth amplifier unit PA4, an amplification factor by the fourth amplifier unit PA4, and so forth. Further, the laser beam reflected by the beam splitter B11 enters a beam profiler B13. The beam profiler B13 measures a beam profile, an intensity distribution, and so forth, of the incident laser beam. With this, the beam profiler B13 measures the profile of the laser beam outputted from the fourth amplifier unit PA4.

Similarly, part of the laser beam transmitted through the beam splitter M47 of the third relay optical system 30-43 is transmitted through a beam splitter B21 provided to an input stage of the monitor box B2 and thereafter enters an output monitor B22. With this, the output monitor B22 detects the intensity (energy) of the laser beam outputted from the fifth amplifier unit PA5, an amplification factor by the fifth amplifier unit PA5, and so forth. Further, the laser beam reflected by the beam splitter B21 enters a beam profiler B23. With this, the beam profiler B23 measures the profile of the laser beam outputted from the fifth amplifier unit PA5.

Next, the fourth amplifier unit PA4 and the fifth amplifier unit PA5 in accordance with the embodiment will be described in detail with reference to the drawings. FIG. 26 is a perspective view illustrating an exterior of the fourth or fifth amplifier unit in accordance with the embodiment. As shown in FIG. 26, the exterior of the fourth amplifier unit PA4 and the fifth amplifier unit PA5, for example, is substantially cubic. Provided to one side of the fourth amplifier unit PA4 are the input window W41 through which a laser beam to be amplified enters the fourth amplifier unit PA4 and the output window W42 through which the amplified laser beam is outputted. Similarly, provided to one side of the fifth amplifier unit PA5 are the input window W51 through which a laser beam to be amplified enters the fifth amplifier unit PA5 and the output window W52 through which the amplified laser beam is outputted.

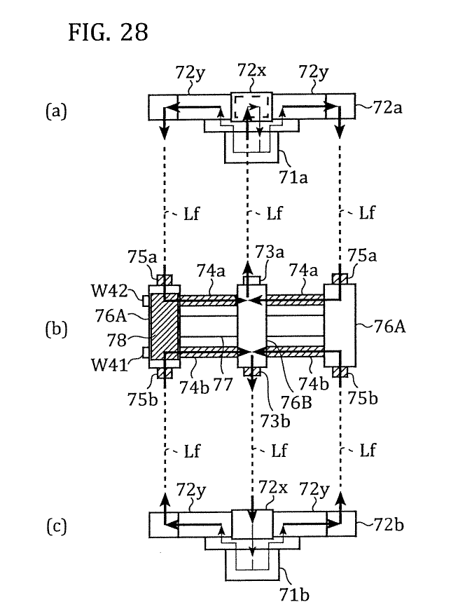

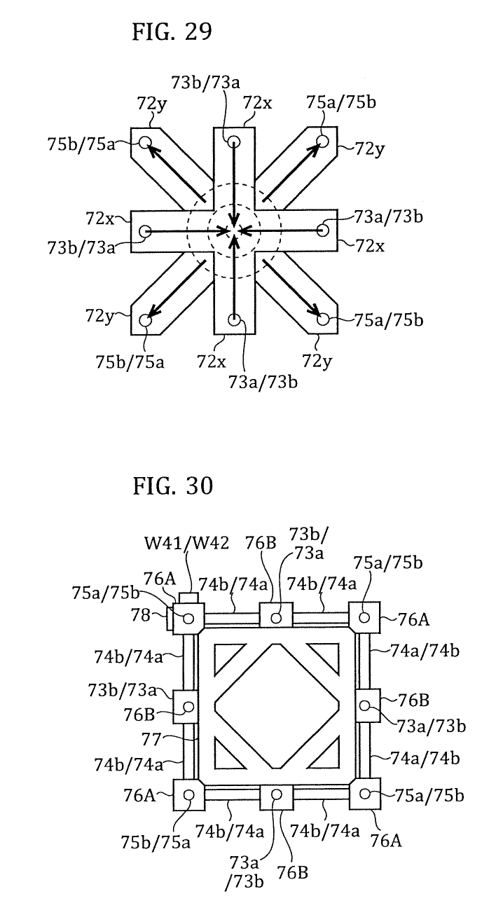

Subsequently, internal configurations of the fourth amplifier unit PA4 and the fifth amplifier unit PA5 in accordance with the embodiment will be described in detail with reference to the drawings. Here, since the internal configuration of the fifth amplifier unit PA5 is similar to the internal configuration of the fourth amplifier unit PA4, only the fourth amplifier unit PA4 will be described. FIG. 27 is a side view illustrating a schematic configuration of the interior of the fourth amplifier unit in accordance with the embodiment. FIG. 28 is an exploded view of the fourth amplifier unit shown in FIG. 27. FIG. 29 is a top view illustrating a schematic configuration of a gas path located at an upper stage of the fourth amplifier unit shown in FIG. 27. FIG. 30 is a top view illustrating a schematic configuration of an amplification path located at a middle stage of the fourth amplifier shown in FIG. 27.

As shown in FIGS. 27 through 30, the fourth amplifier unit PA4 includes two gas paths 72a and 72b which are at the upper and lower levels respectively, and a resonator frame 77 disposed between the two gas paths 72a and 72b.

As shown in FIG. 29, the gas path 72b at the lower level includes four of first gas paths 72x and four of second gas paths 72y. The four of the first gas paths 72x are arranged in a cross shape, for example. Further, the four of the second gas paths 72y are arranged in a cross shape which is rotated by 45° with respect to the first gas paths 72x. Each of the gas paths 72x and 72y is configured of a hollow pipe being quadrangular or circular (or elliptical) in cross-section, for example. Each of the gas paths 72x and 72y is filled with a mixed gas containing CO₂ which serves as a gain medium. A circulation pump 71b for circulating the mixed gas containing CO₂ in the first gas paths 72x into the second gas paths 72y may be provided below the center at which the gas paths 72x and 72y converge.

As shown in FIGS. 27 and 28, the mixed gas containing CO₂ which is pumped into the second gas paths 72y by the circulation pump 71b flows into a lower amplification path 74b of the middle stage (see FIG. 28(a)) through vertical piping 75b connected to an end of the second gas path 72b. The amplification path 74b is an assembly configured of cylindrical pipings. As shown in FIG. 30, the amplification path 74b, for example, is disposed on a periphery of a quadrangular or rectangular resonator frame 77. The amplification path 74b, for example, is anchored onto the resonator frame 77 with aluminum blocks 76A and 76B. As shown in FIGS. 28 through 30, the mixed gas containing CO₂ pumped into the amplification path 74b flows into the first gas paths 72x through vertical piping 73b which branches off at a middle portion in each side of the amplification path 74b, and thereafter is pumped back into the second gas paths 72y by the circulation pump 71b.

Further, as shown in FIG. 30, a laser beam which enters through the input window W41 passes through the lower amplification path 74b. Thus, a flat mirror for deflecting a laser beam by 90° along the amplification path 74b is provided inside the aluminum block 76A which anchors each corner of the amplification path 74b onto the resonator frame 77. The laser beam, after entering through the input window W41, circulates inside the amplification path 74b in a counter-clockwise direction, and is reflected by a return mirror 78 provided to the aluminum block 76A having the input window W41, thereby being guided to an upper amplification path 74a. With this, the laser beam amplified in the lower amplification path 74b enters the upper amplification path 74a.

The amplification path 74a is filled with the mixed gas containing CO₂ pumped from the upper gas path 72a. Note that the mixed gas containing CO₂ circulates in a path formed by the gas path 72a, the vertical piping 73a and 75a, and the amplification path 74a in a similar manner as the mixed gas containing CO₂ circulates in a path formed by the above-described gas path 72b, the vertical piping 73b and 75b, and the amplification path 74b; therefore, the description thereof will be omitted here.

The laser beam which has entered the upper amplification path 74a from the lower amplification path 74b passes through the amplification path 74a. Thus, a flat mirror for deflecting a laser beam by 90° along the amplification path 74a is provided inside the aluminum block 76A which anchors each corner of the amplification path 74a onto the resonator frame 77. The laser beam circulates inside the amplification path 74a in a clockwise direction, and thereafter is outputted outside (to optical unit 30) through the output window W42 provided to the aluminum block 76A having the input window W41.

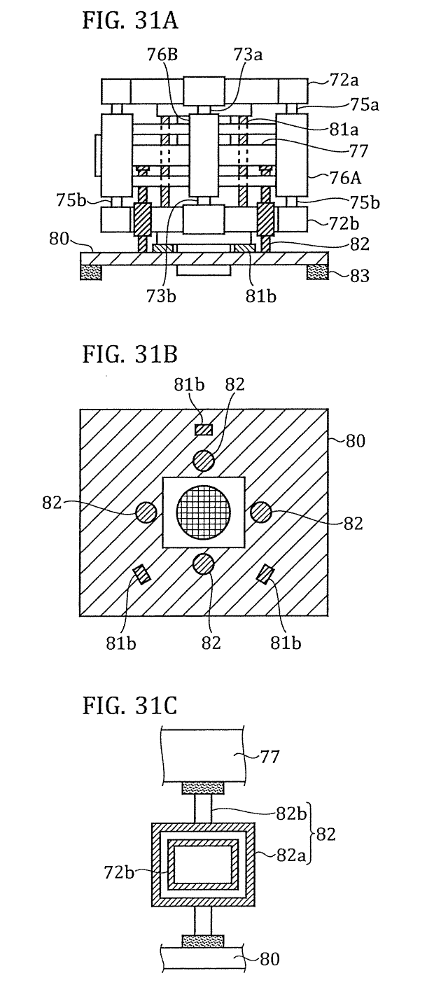

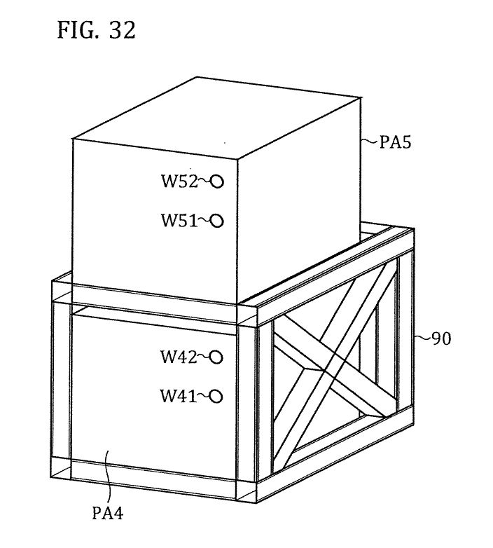

The fourth amplifier unit PA4 and the fifth amplifier unit PA5 having the above-described configuration each include two circulation pumps 71a and 71b. Thus, the fourth amplifier unit PA4 and the fifth amplifier unit PA5 preferably include a configuration for preventing the resonators from vibrating, respectively. FIGS. 31A through 31C schematically illustrate an exemplary antivibration mechanism inside the amplifier in accordance with the embodiment. Note that the configuration of the antivibration mechanism in the fifth amplifier unit PA5 is similar to that in the fourth amplifier unit PA4; thus, only the fourth amplifier unit PA4 will be described here.

As shown in FIGS. 31A through 31C, the internal structure of the fourth amplifier unit PA4 is place on a main amplifier frame 80 which is a base of an outer housing. A plurality of dampers 83, for example, is provided on a lower surface of the main amplifier frame 80. The lower gas path 72b in the internal structure is placed on the main amplifier frame 80 via a damper 81b which is a vibration absorption member. The upper gas path 72a is supported with respect to the lower gas path 72b by a support member 81a which is a vibration absorption member. The connected vertical piping 73b, 75b, 73a, and 75a are constituted by bellows piping so that vibration at the gas paths 72b and 72a is not propagated to the aluminum blocks 76A and 76B.

Meanwhile, the resonator frame 77 is supported with respect to the main amplifier frame 80 by a damper mechanism 82 which is a vibration absorption member. As shown in FIG. 31C, the damper mechanism 82 includes a support unit having a bypass unit 82a and a damper 82b. The bypass unit 82a bypasses without making contact with the gas path 72b. The damper 82b prevents vibration propagated from the main amplifier frame 80 from propagating to the resonator frame 77.

In this way, the gas paths 72a and 72b including the circulation pumps 71a and 71b and the resonator frame 77 onto which the amplification paths 74a and 74b are anchored are separately supported with respect to the main amplifier frame 80 by separate vibration absorption mechanisms. With this, the resonator frame 77 is efficiently prevented from vibrating by the vibration generated at the circulation pumps 71a and 71b. As a result, the vibration generated at an optical element constituting a beam path inside the amplifier can be suppressed.

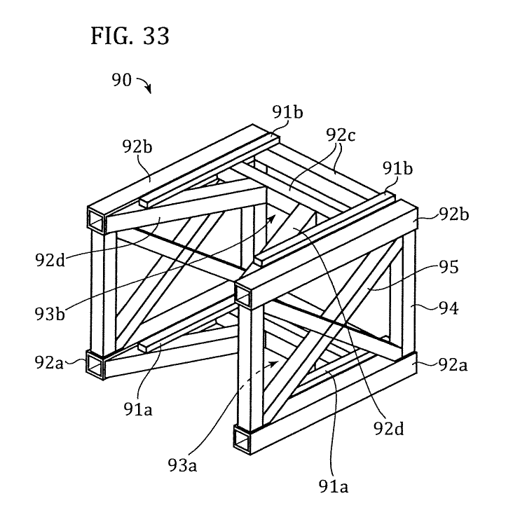

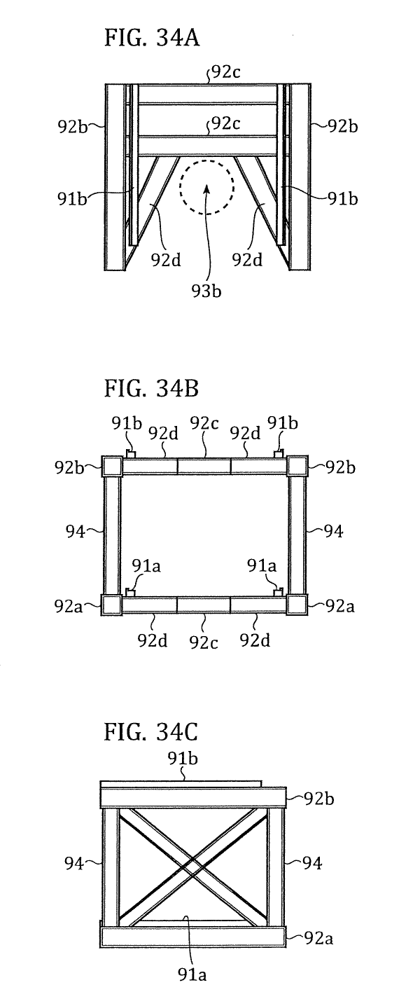

Further, the fourth amplifier unit PA4 and the fifth amplifier unit PA5 in accordance with the embodiment are stacked on top of each other, as has been described above, in order to reduce the occupying floor area. At this time, as shown in FIG. 32, for example, the fifth amplifier unit PA5 is preferably placed above the fourth amplifier unit PA4 using a frame 90 which is vibratory-separated with respect to the lower fourth amplifier unit PA4. FIG. 32 is a perspective view illustrating a schematic configuration of the fourth and fifth amplifier units which are stacked on top of each other in accordance with the embodiment. FIG. 33 is a perspective view illustrating a schematic configuration of the frame in accordance with the embodiment. FIGS. 34A through 34C are external views of the frame shown in FIG. 33. Note that FIG. 34A is a top view of the frame 90, FIG. 34B is a front view of the frame 90, and the FIG. 34C is a side view of the frame 90. As shown in FIG. 32, by configuring such that the fifth amplifier unit PA5 is not placed directly on the fourth amplifier unit PA4, the vibration propagated between the fifth amplifier unit PA5 and the fourth amplifier unit PA4 can be suppressed.

Further, as shown in FIGS. 33 through 34C, the frame 90, for example, includes beams 92a and 92b, a crossbeam 92c, a guide member 92d, slider rails 91a and 91b, a column 94, and a diagonal beam 95. The beams 92a are aligned in parallel with each other with a space provided therebetween at the lower parts of the columns 94. Similarly, the beams 92b are aligned in parallel with each other with a space provided therebetween at the upper parts of the columns 94. The two crossbeams 92c set a space between the lower two beams 92a and a space between the upper two beams 92b. The guide members 92d constitute a pump accommodation unit 93a or 93b which accommodates the circulation pump 71b projecting from a bottom surface of the fourth amplifier unit PA4 or the fifth amplifier unit PA5. The slier rails 91a are arranged in parallel with the lower two beams 92a. The slider rails 91b are arranged in parallel with the upper two beams 92b. The four columns 94 and the diagonal beam 95 support the upper two beams 92b with respect to the lower two beams 92a.

The lower fourth amplifier unit PA4 is placed on the lower slider rails 91a. With this, the fourth amplifier unit PA4 can be placed into and out of the frame 90 with ease. Similarly, the upper fifth amplifier unit PA5 is placed on the upper slider rails 91b. With this, the fifth amplifier unit PA5 can be placed into and out of the frame 90 with ease.

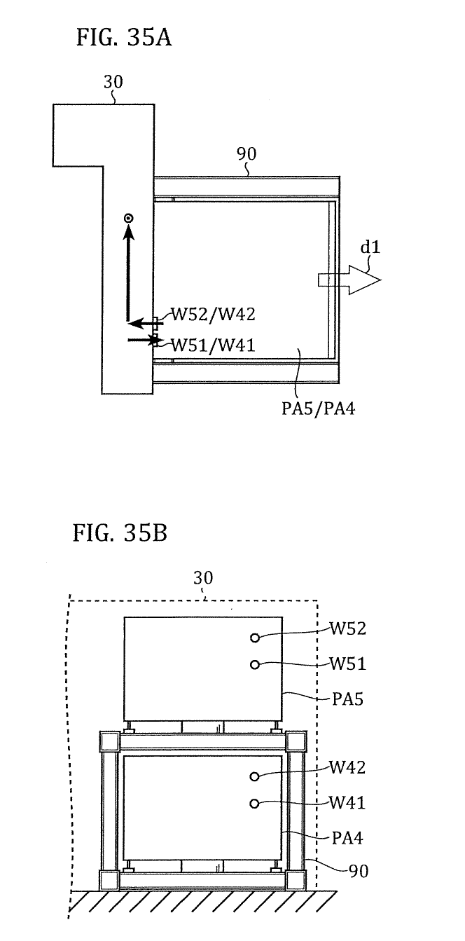

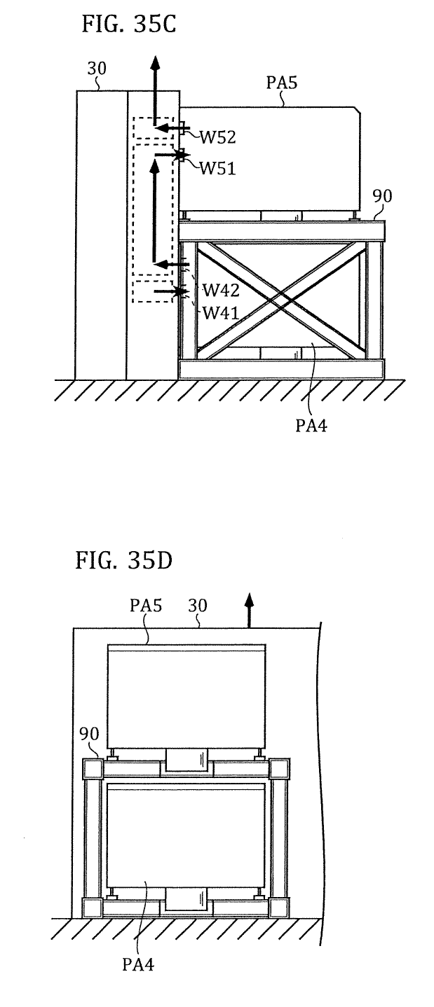

As shown in FIGS. 35A through 35D, the fourth amplifier unit PA4 and the fifth amplifier unit PA5 stacked on top of each other using the above-described frame 90 is disposed such that the input windows W41 and W51 and the output windows W42 and W52 face the optical unit 30. In this case, the fourth amplifier unit PA4 and the fifth amplifier unit PA5 can be movable in a direction (movement direction d1) perpendicular to the surface thereof facing the optical unit 30. Note that FIGS. 35A through 35D are views illustrating the connection between the optical unit and the fourth and fifth amplifier units in accordance with the embodiment. FIG. 35A is a top view thereof, FIG. 35B is a front view thereof, FIG. 35C is a side view thereof, and FIG. 35D is a rear view thereof.

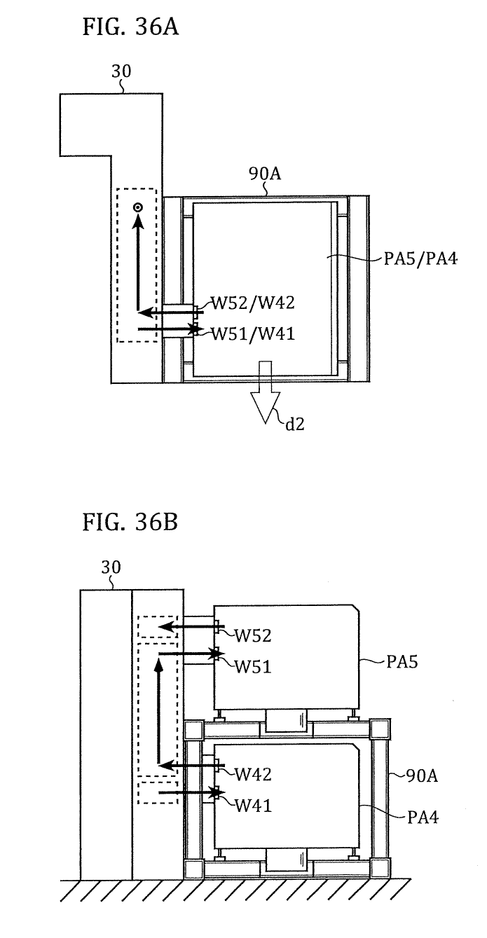

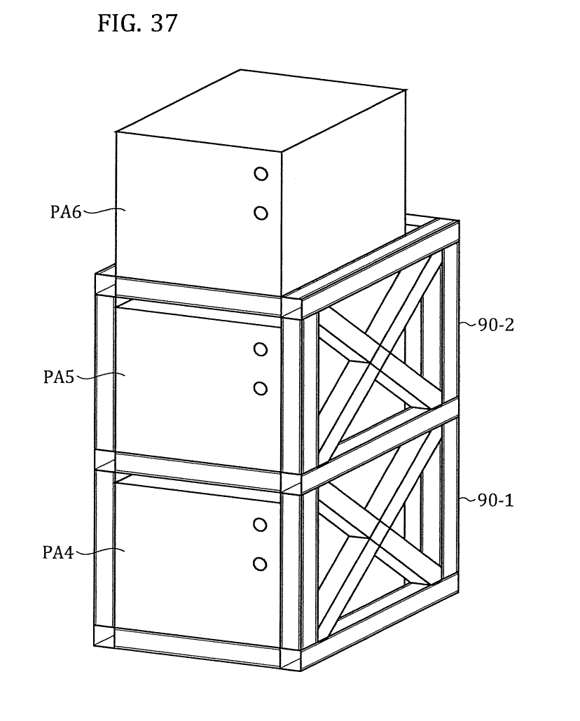

Further, as shown in FIGS. 36A and 36B, the fourth amplifier unit PA4 and the fifth amplifier unit PA5 in accordance with the embodiment may be configured such that they can be moved in a direction (movement direction d2) parallel to the surface thereof facing the optical unit 30. Note that FIGS. 36A and 36B are views illustrating another connection between the optical unit and the fourth and fifth amplifier units in accordance with the embodiment. FIG. 36A is a top view thereof, and FIG. 36B is a side view thereof.

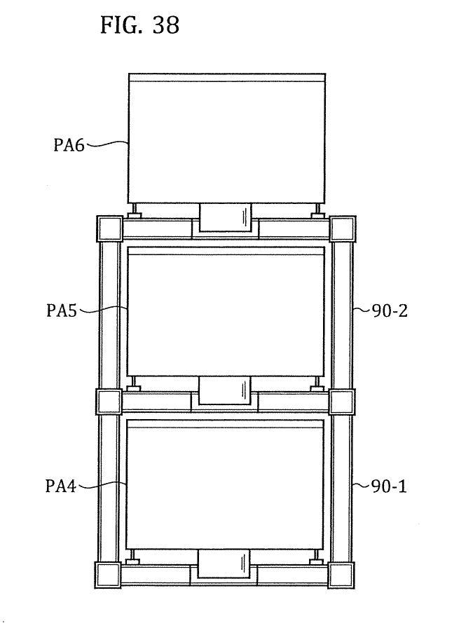

In the embodiment, the two amplifiers (fourth amplifier unit PA4 and fifth amplifier unit PA5) being stacked on top of each other have been exemplified. However, as shown in FIGS. 37 and 38, for example, three amplifiers (fourth through sixth amplifier units PA4 through PA6) may be stacked on top of one another by placing an upper frame 90-2 on a lower frame 90-1. Furthermore, more than three amplifiers may be stacked on top of one another. Note that FIG. 37 is a perspective view illustrating an exemplary configuration of three amplifier being stacked on top of one another in accordance with the embodiment. FIG. 38 is a rear view illustrating an exemplary configuration of three amplifiers being stacked on top of one another in accordance with the embodiment. In FIGS. 37 and 38, the frames 90-1 and 90-2 are each configured similarly to the frame 90.

Further, in the embodiment, a case where the lower fourth amplifier unit PA4 and the upper fifth amplifier unit PA5 are placed in the integrated frame 90 has been exemplified. However, the embodiment is not limited thereto. A frame in which the lower fourth amplifier unit PA4 is placed, for example, may be a separate frame from that in which the upper fifth amplifier unit PA5 is placed. In this case, the frame in which the fourth amplifier unit PA4 is placed is, for example, configured of the lower beams 92a, the crossbeams 92c, the guide members 92d, and the slider rails 91a of the frame 90. On the other hand, the frame in which the fifth amplifier unit PA5 is placed, for example, is configured such that one of the lower crossbeams 92c, the guide members 92d, and the slider rails 91a in the frame 90 are omitted. The frame in which the fourth amplifier unit PA4 is placed is preferably smaller so that it can be accommodated in the frame in which the fifth amplifier unit PA5 is placed without making contact with the interior thereof.

As has been described so far, according to the embodiment, since the laser device 1 is accommodated in the installation space 100 with at least one unit thereof being movable, the laser device 1 can be accommodated in a limited space while securing a work space for performing the maintenance work on the laser device 1. Further, an extreme ultraviolet light generation device including such laser device 1 can be obtained.

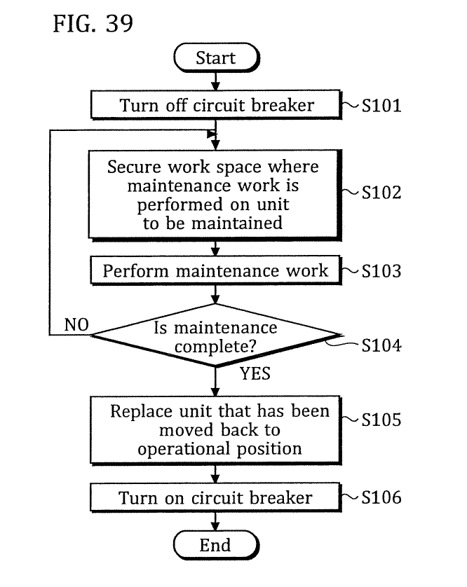

Here, FIG. 39 shows a maintenance procedure in accordance with the embodiment. As shown in FIG. 39, when carrying out the maintenance work, an operator enters the work space SP secured in front of the switchboard 50 and turns off the circuit breaker on the switchboard 50 (Step S101). Then, a unit (such as fourth power source unit D4) is moved in order to secure a work space in which the maintenance work is carried out on a unit (such as fifth power source unit D5) to be maintained (Step S102). In this way, the work space in which the maintenance work is carried out on the unit to be maintained is secured, and subsequently the maintenance work on the unit is carried out (Step S103). Thereafter, whether or not the maintenance work needs to be carried out on another unit is determined (Step S104). If the maintenance work needs to be carried out on another unit (Step S104: No), the flow returns to Step S102, and the maintenance work is carried out on another unit (Step S102 and S103). Alternatively, if the maintenance work does not need to be carried out on another unit (Step S104: Yes), the unit that has been moved to secure the work space is moved back a predetermined location (Step S105), and the circuit breaker on the switchboard 50 is switched back on (Step S106), and the process is terminated.

Further, the above-described embodiments and the modifications thereof are merely examples for implementing the present disclosure, and the present disclosure is not limited thereto. Further, making various modifications in accordance with the specification is within the scope of the present disclosure, and it is apparent that the various other embodiments can be made from the above description without departing from the scope of the present disclosure. For example, it is needless to state that the modifications indicated for each of the embodiments can be applied to the other embodiments.

1. A laser device which is installed within a predetermined space and on a predetermined floor area, the laser device comprising:
a master oscillator;
at least one amplifier unit that amplifies a laser beam outputted from the master oscillator;
at least one power source unit that supplies excitation energy to the at least one amplifier unit; and
a movement mechanism which enables at least one among the at least one amplifier unit and the at least one power source unit to be moved in a direction parallel with a floor surface.

2. The laser device of claim 1, wherein
a switchboard for distributing power to the at least one power source unit is provided inside the predetermined space, and
the movement mechanism enables at least one among the at least one amplifier unit and the at least one power source unit to be moved with respect to the switchboard.

3. The laser device of claim 2, wherein
at least one among the at least one amplifier unit and the at least one power source unit is disposed in front of the switchboard, and
the movement mechanism enables the at least one among the at least one amplifier unit and the at least one power source unit to be moved away from the switchboard to secure a work space therebetween.

4. The laser device of claim 1, wherein
the movement mechanism includes:
at least one rail disposed on a floor surface of the predetermined space;
at least one member, provided on a bottom surface of at least one among the at least one amplifier unit and the at least one power source unit, which slidably engages the at least one rail.

5. The laser device of claim 4, wherein the at least one member is a caster.

6. The laser device of claim 4, wherein
the at least one rail is a slide gear rail, and
the at least one member is a slide gear.

7. The laser device of claim 1, further comprising a positioning member for determining at least one of a position where a unit to be moved with the movement mechanism is placed when the unit is under maintenance and a position where a unit to be moved with the movement mechanism is placed when the unit is in operation.

8. The laser device of claim 1, wherein the movement mechanism includes a movement assist mechanism which generates power for assisting the movement of the unit.

9. The laser device of claim 1, wherein the at least one amplifier unit includes a region filled with a gain medium containing CO₂ gas.

10. The laser device of claim 1, further comprising an optical unit that regulates a beam path of the laser beam outputted from the at least one amplifier unit.

11. An extreme ultraviolet light generation device, comprising:
a laser device, disposed in a predetermined space, including a master oscillator, at least one amplifier unit that amplifies a laser beam outputted from the master oscillator, at least one power source unit that supplies excitation energy to the at least one amplifier unit, a switchboard for distributing power to the at least one power source unit, and a movement mechanism for enabling at least one among the at least one amplifier unit and the at least one power source unit to be moved with respect to the switchboard; and
a chamber, disposed outside the predetermined space, in which a target serving as a source of extreme ultraviolet light is irradiated with a laser beam outputted from the laser device.
